(19) United States
(12) Patent Application Publication
(10) Pub. No.: US 2014/0069624 A1
(43) Pub. Date: Mar. 13, 2014

(54) FABRICS AND OTHER SUBSTRATES WITH ENHANCED COOLING

(71) Applicant: Kraton Polymers U.S. LLC, Houston, TX (US)

(72) Inventors: Richard Ivey Blackwell, Katy, TX (US); Todd Schroeder, The Woodlands, TX (US); Kuitian Tan, Katy, TX (US); Jens Kohnert, Alpen (DE); Bert Krutzer, Duiven (NL); Alem Tadesse, Richmond, TX (US); Steven Huynh, Katy, TX (US); Chad Rankin, Houston, TX (US)

(73) Assignee: Kraton Polymers U.S. LLC, Houston, TX (US)

(21) Appl. No.: 14/021,169

(22) Filed: Sep. 9, 2013

Related U.S. Application Data
(60) Provisional application No. 61/699,589, filed on Sep. 11, 2012.

(51) Int. Cl. F28F 21/06; D06N 3/04; D21H 19/68; B05D 5/00

(52) U.S. Cl. CPC F28F 21/06; B05D 5/00; D06N 3/045; D21H 19/68
USPC 165/185; 427/256; 428/195.1; 428/196; 428/36.9; 428/211.1; 2/69; 2/227; 2/228; 2/239; 2/400; 2/181; 2/159; 2/171

(57) ABSTRACT

An article made up of a substrate which has a polymer coating applied to at least one of its surfaces, wherein the polymer coating forms an interrupted pattern such that at least 10% to 80% of the substrate surface remains uncoated, and wherein the polymer coating comprises a moisture permeable polymer.

### FIELD OF THE INVENTION

The present disclosure relates to coated fabrics and other substrates to promote enhanced cooling. In particular, the present disclosure relates to fabrics and other substrates having a moisture permeable polymer coating applied in an interrupted pattern, where a portion of the fabric surface remains uncoated. Particular applicability of the present disclosure relates to sportswear having moisture wicking properties. The moisture permeable polymer can be a sulfonated polymer, and in particular a sulfonated block copolymer having at least two polymer end blocks that contain little or no sulfonic acid or sulfonate functionality and at least one polymer interior block which contains an effective amount of sulfonic acid or sulfonate functionality.

### BACKGROUND OF THE INVENTION

In recent years, the apparel industry has been increasingly challenged to develop more efficient ways to regulate body temperature, particularly during strenuous activity. Accordingly, a greater focus has been on achieving sporting garments and fabrics with enhanced cooling properties. The human body has a natural cooling mechanism through the perspiration and natural skin moisture, and accordingly, moisture management has been one route for controlling body heat. A common method is to employ garments having particular fibers which have a “wicking” action, wicking moisture away from the body and allowing the moisture to rapidly evaporate off the fabric surface.

The effect of wicking fiber is two-fold: 1) wicking moisture away from the body encourages the body to continue to sweat, which is a natural cooling mechanism, and 2) the act of evaporation of moisture is an endothermic process which creates localized cooling at the fabric surface. The latter process can be referred to as “evaporative cooling”.

In traditional wicking fabric, hydrophilic fibers have been used to attract and draw moisture away from the skin. Other types of wicking fibers can be used however, for example companies such as Under Armour Inc. and Columbia Sportswear Co. helped popularize hydrophobic blends of fibers for improving wicking activity and increasing cooling of the garment.

Additionally, styrenic block copolymers are well known in the art. Generally, styrenic block copolymers (“SBC”) can comprise internal polymer blocks and terminal end polymer blocks comprising chemically different monomer types thereby providing particular desirable properties. As an example, in a more common form, SBC's may have internal blocks of conjugated diene and external blocks having aromatic alkenyl arenes. The interaction of the differing properties of the polymer blocks allow for different polymer characteristics to be obtained. For example, the elastomer properties of internal conjugated diene blocks along with the “harder” aromatic alkenyl arenes external blocks together form polymers which are useful for an enormous variety of applications. Such SBC's can be prepared through sequential polymerization and/or through coupling reactions.

It is known also that SBC can be functionalized in order to further modify their characteristics. For example, SBC can be modified by introducing functional groups such as carboxylic acids, esters or amides, phosphonate groups or sulfonate groups to the backbone of the polymer. Methods for incorporating functional groups into polymers containing unsaturation are taught, for example, in U.S. Pat. No. 3,135,716, U.S. Pat. No. 3,150,209, and U.S. Pat. No. 4,409,357. Alternative procedures in which functional groups are incorporated into hydrogenated SBC are taught, for example, in U.S. Pat. No. 4,578,429, and U.S. Pat. No. 4,970,265.

More recently, U.S. Pat. No. 7,737,224 to Willis et al., disclosed the preparation of sulfonated polymer and illustrated a sulfonated block copolymer that is solid in water comprising at least two polymer end blocks and at least one saturated polymer interior block wherein each end block is a polymer block resistant to sulfonation and at least one interior block is a saturated polymer block susceptible to sulfonation, and wherein at least one interior blocks is sulfonated to the extent of 10 to 100 mol percent of the sulfonation susceptible monomer in the block. The sulfonated block copolymers are described having high moisture-vapor permeability while at the same time having good dimensional stability and strength in the presence of water.

Additionally, US 2012/0077400 discloses films comprising a combination of at least one elastomeric styrenic block copolymer which is optionally functionalized with functional groups different from sulfonic acid or sulfonate ester functional groups, and at least one sulfonated block copolymer. The Application discloses that such films are elastic and are moisture-vapor permeable, and thus useful, for example, as coatings in breathable clothing and footwear, industrial workwear including cleanroom coveralls, in medical applications such as wound dressings and protective clothing, for bed sheets and mattress or seat covers, and other non-apparel applications.

### SUMMARY OF THE DISCLOSURE

In some embodiments, the present disclosure relates to an article including

a substrate which has a polymer coating applied to at least one of its surfaces, wherein the polymer coating forms an interrupted pattern such that at least 10% to 80% of the substrate surface remains uncoated, and wherein the polymer coating comprises a moisture permeable polymer.

In further embodiments the moisture permeable polymer is a sulfonated polymer with a hydrocarbon backbone. Additionally, the sulfonated polymer can be a sulfonated block copolymer having at least one end block A and at least one interior block B wherein each A block contains essentially no sulfonic acid or sulfonate ester functional groups and each B block is a polymer block containing from about 10 to about 100 mol % sulfonic acid or sulfonate ester functional groups based on the number of sulfonation susceptible monomer units of the B block. In some embodiments, the sulfonated polymer is blended with other styrenic block copolymers which have not been sulfonated, including SEBS and SEPS block copolymers.

In further embodiments, the substrate is an air permeable fabric. In additional examples, the fabric is moisture wicking and comprises hydrophobic fibers.

In further embodiments, the fabric is moisture wicking due to capillary action. Additionally, at least one surface of the fabric can be treated with a hydrophilic finish. In further embodiments, the fabric is moisture wicking due to capillary action. In further embodiments, the hydrophobic fibers comprise a polyester. In additional embodiments, the fabric is moisture wicking and comprises hydrophilic fibers.

In some embodiments, the fabric is a garment selected from the group consisting of a shirt, t-shirt, pants, shorts, arm bands, socks, underwear, sweat band, handkerchief, shoes, gloves, tents and hats and uniforms. The article or fabric is in the form of a garment or a part of a garment having the polymer coating on the surface of the garment oriented toward the wearer.

In some embodiments, the substrate can be cellulosic material, paper, rubber or plastic, and can include foams. In additional embodiments, the cellulosic material, paper, or plastic is in the form of a label for beverage bottles or cans. In some embodiments, the article is in the shape of a sleeve and shaped for enclosing a portion of a can or bottle.

In some embodiments, at least 20% to 75% of the substrate surface remains uncoated. In some embodiments, the interrupted pattern comprises irregular or regular geometric shapes, outlines of irregular or regular geometric shapes, broken or unbroken lines, or combinations thereof. Additionally, the interrupted pattern can be in the form of a plurality of discrete dots.

In further embodiments, the present disclosure includes a process for making an article having a substrate, such process including:

preparing a solution or dispersion containing a sulfonated hydrocarbon copolymer and at least one solvent and having a solids content of at least 8 to 35 wt %,

coating said solution or dispersion on at least one surface of a substrate in an interrupted pattern such that at least 10% to 80% of the substrate surface remains uncoated.

In some embodiments, the solution or dispersion comprises an organic solvent. In further embodiments, the solution or dispersion comprises a cyclic or acyclic aliphatic solvent. The organic solvent can include at least one heterocyclic solvent. In other examples, the organic solvent comprises an aromatic hydrocarbon. In further examples, the organic solvent includes an aromatic hydrocarbon. Additionally, the solution or dispersion can be a mixture of a polar and a non-polar solvent. In some embodiments, the organic solvent includes Tetrahydrofuran or toluene, which can be further mixed with a C₁-C₆ alcohol. The solution or dispersion can include an aqueous dispersion. In some embodiments, the viscosity will be below 12,000 cps, or alternatively a low shear viscosity below 6,000 cps.

In further embodiments, disclosed herein is a method of cooling a container or subject including:

covering at least a portion of the surface of the container or of the skin of the subject with an article comprising

a substrate which has a polymer coating applied to at least one of its surfaces, wherein the polymer coating forms an interrupted pattern such that at least 10% to 80% of the fabric surface remains uncoated, and wherein the polymer coating comprises a moisture permeable polymer,

and wherein the substrate is oriented such that the coated surface faces the surface of the container or faces the skin of the subject.

In such embodiments, the moisture permeable polymer is a sulfonated polymer with a hydrocarbon backbone. The sulfonated polymer is a sulfonated block copolymer having at least one end block A and at least one interior block B wherein each A block contains essentially no sulfonic acid or sulfonate ester functional groups and each B block is a polymer block containing from about 10 to about 100 mol % sulfonic acid or sulfonate ester functional groups based on the number of sulfonation susceptible monomer units of the B block.

In further embodiments, the coating swells under the influence of humidity or moisture to induce a cooling effect capable of reducing the temperature of the surface of the container or the skin of the subject. In additional embodiments, the subject is a human being and the coating contacts at least a portion of the skin. Further, the article can be a garment and the coating is on a surface of the garment facing the skin. In additional embodiments, the substrate is a fabric.

The article can be selected from the group consisting of a shirt, t-shirt, pants, shorts, arm bands, socks, underwear, sweat band, handkerchief, shoes, gloves, hats and uniforms.

In further embodiments, the container is in form of a can or bottle, and the coating contacts at least a portion of the surface. Additionally, the article can be in the form of a sleeve adapted to fit around the body of the container, or in form of a label permanently attached to the body of the container.

Additionally, the substrate can be cellulosic material or paper or plastic. The container can be made up of a material selected from metal, plastic, and glass. Additionally, the article can be made from fabric, rubber, or plastic, and the coating is located at least on the surface of the article adapted to contact the container.

### BRIEF DESCRIPTION OF THE FIGURES

FIG. 1 illustrates a thermal laminate of macroporous SBC-1 membrane on polyester fabric.

FIG. 2 illustrates a SBC-1 coated in a dot pattern on the surface of a polyester fabric from a cyclohexane based solution.

FIG. 3 illustrates a thermal image of a drop of water on the surface of a SBC-1 membrane (left) and a wicking polyester fabric (right).

FIG. 4 illustrates temperature vs. time captured from the thermal images described in FIG. 3.

FIG. 5 illustrates a thermal image of a droplet of water on the surface of an SBC-1/SEBS blend membrane (left) and a wicking polyester fabric (right).

FIG. 6 illustrates a thermal image of a water droplet on the sample described in FIG. 1.

FIG. 7 illustrates a thermal image of water droplet on polyester fabric coated with SBC-1 from the sample described in FIG. 2 with the temperature scale in ° F.

FIG. 8 illustrates a thermal image of water droplet on polyester fabric coated with SBC-1 from a 25% solids solution in THF/EtOH with temperature scale in ° F.

FIG. 9 illustrates the influence of % solids and gauge thickness on ΔT for one embodiment.

FIG. 10 illustrates the influence of % solids and gauge thickness on dry time for one embodiment.

FIG. 11 illustrates the influence of % RH on the absolute temperature and ΔT of the Nexar polymer dots and the polyester fabric.

FIG. 12 illustrates the influence of air flow on the absolute temperature of the Nexar polymer dots and the polyester fabric.

FIG. 13 illustrates the absolute temperature of a water droplet placed on three different membranes with varying swelling capacities.

FIG. 14a and FIG. 14b illustrate the outer surface of polyester fabric coated with SBC-1 dots (coating is on the underside of the fabric) before and after saturation with moisture vapor.

FIG. 15 illustrates ΔT vs. time at two ambient humidities of a polyester fabric coated with SBC-1 dots following saturation with moisture vapor.

FIG. 16 illustrates thermal images of samples described in FIG. 16 with temperature scale in ° F.

FIG. 17 illustrates a SBC-1 coated in a dot pattern on the surface of polyurethane foam after exposure to 80% relative humidity.

FIG. 18 illustrates relationship between viscosity and solids content for toluene/alcohol solutions.

FIG. 19 illustrates Relationship between ΔT (Thermal Contrast) and Solids Content for toluene/alcohol solutions.

FIG. 20 illustrates the results of a pre-spritzed SBC-1 in contact with a container filled with room temperature water.

FIG. 21 illustrates the results of a pre-spritzed SBC-1 in contact with a container filled with room temperature water.

FIG. 22 illustrates the results of a pre-spritzed SBC-1 in contact with a container filled with cold tap water.

FIG. 23 illustrates the results of a pre-spritzed SBC-1 in contact with a container filled with cold tap water.

### DETAILED DESCRIPTION OF THE DISCLOSURE

A detailed description of embodiments is disclosed herein; however, it is to be understood that the described embodiments are merely exemplary of the disclosure and that the disclosure may be embodied in various and alternative forms of the described embodiments. Therefore, specific structural and functional details which are addressed in describing the embodiments herein are not to be interpreted as limiting, but merely as a basis for the claims and as a representative basis for teaching one skilled in the art to variously employ the present disclosure.

All publications, patent applications, and patents mentioned herein are incorporated by reference in their entirety. In the event of conflict, the present specification, including definitions, is intended to control.

Unless specifically stated otherwise, all technical terms used herein have the meaning as commonly understood by those skilled in the art.

With respect to all ranges disclosed herein, such ranges are intended to include any combination of the mentioned upper and lower limits even if the particular combination is not specifically listed.

Unless specifically stated otherwise, the expression “coated” or “coating” means the application or bonding of a polymer by any means to the substrate surface and thus forming a film or membrane on the substrate surface.

The term “bonded,” or “bonding” encompasses attachment of a polymer to a substrate either by coating or lamination or other means, whereby a bond is formed between a polymer membrane and the substrate or other material.

The expression “saturated” refers to the maximum amount of water that a cast film immersed in water can absorb at room temperature and pressure.

The expression “partially saturated” refers to a condition where a cast film that has absorbed less than the maximum amount of water that can be absorbed when water is applied to the film at room temperature and pressure.

It will be understood by those skilled in the art that the term “film” disclosed herein may also be referred to as a membrane which is moisture permeable but air impermeable.

Disclosed herein are articles comprising:

a substrate which has a polymer coating applied to at least one of its surfaces, wherein the polymer coating forms an interrupted pattern such that a portion of the substrate surface remains uncoated, and wherein the polymer coating comprises a moisture permeable polymer.

In one aspect it has been surprisingly found that the application of a moisture permeable polymer coating in an interrupted pattern onto a substrate enhances the cooling properties of fabric. Preferably the substrate is an air permeable “breathable” fabric, and still more preferably is a wicking fabric.

In some embodiments, the polymer to be employed is a moisture permeable polymer. In further embodiments the polymer swells with absorption of water. In preferred embodiments, the polymer is a sulfonated polymer or copolymer. According to several embodiments, the moisture permeable polymer is a sulfonated polymer, and is preferably a sulfonated block copolymer having at least one end block A and at least one interior block B wherein each A block contains essentially no sulfonic acid or sulfonate ester functional groups and each B block is a polymer block containing from about 10 to about 100 mol % sulfonic acid or sulfonate ester functional groups based on the number of sulfonation susceptible monomer units of the B block.

The fabrics herein are preferably employed as a wearable fabric, for example against the skin. In this way, the moisture from the skin, including perspiration from physical exertion, interacts with the fabric for enhanced cooling of the body of the wearer. While not wishing to be held to any particular principle or technical theory, it is hypothesized herein that the cooling properties are caused by the polymer's ability to actively absorb and bind water, effectively creating a controlled release of the water, which allows for cooler temperatures to be achieved and maintained for extended periods of time.

There are several factors which contribute to providing the cooling action. It is believed that the action of the polymer drawing the water away from the skin (or other substrate to be cooled) in itself causes cooling. Furthermore it is hypothesized that the cooling properties are enhanced at least in part by the cyclic swelling and de-swelling of the polymer when exposed to moisture or moisture vapor. Energy is removed during this process thus causing cooling.

Additionally, a wicking fabric can contribute to the cooling effect. In particular, it is believed the wicking fabric can draw out moisture absorbed in the polymer, thus further aiding the spreading of the moisture and promotion of evaporation. Thus at least the transportation, swelling, and spreading of the moisture drawn from the skin aids in providing a cooling effect. These aspects enhance evaporative cooling of the fabric.

Accordingly, it is currently believed that the cooling effect which is provided by the polymer coating involves energy consumption due to swelling of the polymer coating under the influence of moisture or humidity as well as energy consumption due to evaporation of the moisture from the coating.

In additional embodiments, the substrate can be cellulosic material, rubber or plastic. Additionally, the coated substrates can be used for cooling containers, beverage containers, as well as glass and plastic bottles and cans.

### Sulfonated Block Copolymer Film

In a preferred embodiment, the moisture permeable polymer as disclosed herein is composed of or includes a sulfonated block copolymer. The sulfonated block copolymer disclosed herein has particular advantageous swelling and water transport properties, thus having particular applicability as a moisture permeable polymer coating for cooling purposes.

In some embodiments, the compositions of the present disclosure include the sulfonated block copolymers described in U.S. Pat. No. 7,737,224 to Willis et al. Furthermore, the sulfonated block copolymers, including those described in U.S. Pat. No. 7,737,224, may be prepared according to the process of WO 2008/089332 to Dado et al. or the process of U.S. Pat. No. 8,012,539 to Handlin et al. These specific sulfonated block copolymers are suspected to be particularly advantageous for obtaining a durable polymer coating.

1. Sulfonated Block Copolymers

The block copolymers needed to prepare the sulfonated block copolymers may be made by a number of different processes, including anionic polymerization, moderated anionic polymerization, cationic polymerization, Ziegler-Natta polymerization, and living chain or stable free radical polymerization. Anionic polymerization is described below in more detail, and in the referenced documents. Moderated anionic polymerization processes for making styrenic block copolymers are disclosed, for example, in U.S. Pat. No. 6,391,981, U.S. Pat. No. 6,455,651 and U.S. Pat. No. 6,492,469, each of which is incorporated herein by reference. Cationic polymerization processes for preparing block copolymers are disclosed, for example, in U.S. Pat. No. 6,515,083 and U.S. Pat. No. 4,946,899, each of which is incorporated herein by reference.

Living Ziegler-Natta polymerization processes that can be used to make block copolymers were recently reviewed by G. W. Coates, P. D. Hustad, and S. Reinartz in Angew. Chem. Int. Ed., 41, 2236-2257 (2002); a subsequent publication by H. Zhang and K. Nomura (J. Am. Chem. Soc., Comm., 2005) describe living Ziegler-Natta techniques for making styrenic block copolymers specifically. The extensive work in the field of nitroxide mediated living radical polymerization chemistry has been reviewed; see C. J. Hawker, A. W. Bosman, and E. Harth, Chem. Rev., 101(12), 3661-3688 (2001). As outlined in this review, styrenic block copolymers can be synthesized by living or stable free radical techniques. Nitroxide mediated polymerization methods are preferred living chain or stable free radical polymerization processes when preparing the precursor polymers.

2. Polymer Structure

One aspect of the disclosure relates to the polymer structure of the sulfonated block copolymers. In one embodiment, the neutralized block copolymers have at least two polymer end or outer blocks A and at least one saturated polymer interior block B wherein each A block is a polymer block which is resistant to sulfonation and each B block is a polymer block which is susceptible to sulfonation.

Preferred block copolymer structures have the general configuration A-B-A, (A-B)n(A), (A-B-A)n, (A-B-A)nX, (A-B)nX, A-B-D-B-A, A-D-B-D-A, (A-D-B)n(A), (A-B-D)n(A), (A-B-D)nX, (A-D-B)nX or mixtures thereof, where n is an integer from 2 to about 30, X is coupling agent residue and A, B and D are as defined hereinafter.

Most preferred structures are linear structures such as A-B-A, (A-B)2X, A-B-D-B-A, (A-B-D)2X, A-D-B-D-A, and (A-D-B)2X and radial structures such as (A-B)nX and (A-D-B)nX where n is 3 to 6. Such block copolymers are typically made via anionic polymerization, stable free radical polymerization, cationic polymerization or Ziegler-Natta polymerization. Preferably, the block copolymers are made via anionic polymerization. It will be understood by those skilled in the art that in any polymerization, the polymer mixture will include a certain amount of A-B diblock copolymer, in addition to any linear and/or radial polymers. The respective amounts have not been found to be detrimental.

The A blocks are one or more segments selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof. If the A segments are polymers of 1,3-cyclodiene or conjugated dienes, the segments will be hydrogenated subsequent to polymerization of the block copolymer and before sulfonation of the block copolymer.

The para-substituted styrene monomers are selected from para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene and mixtures of the above monomers. Preferred para-substituted styrene monomers are para-t-butylstyrene and para-methylstyrene, with para-t-butylstyrene being most preferred. Monomers may be mixtures of monomers, depending on the particular source. It is desired that the overall purity of the para-substituted styrene monomers be at least 90%-wt., preferably at least 95%-wt., and even more preferably at least 98%-wt. of the desired para-substituted styrene monomer.

When the A blocks are polymer segments of ethylene, it may be useful to polymerize ethylene via a Ziegler-Natta process, as taught in the references in the review article by G. W. Coates et al, as cited above, which disclosure is herein incorporated by reference. It is preferred to make the ethylene blocks using anionic polymerization techniques as taught in U.S. Pat. No. 3,450,795, which disclosure is herein incorporated by reference. The block molecular weight for such ethylene blocks will typically be between about 1,000 and about 60,000.

When the A blocks are polymers of alpha olefins of 3 to 18 carbon atoms, such polymers are prepared by via a Ziegler-Natta process, as taught in the references in the above-cited review article by G. W. Coates et al. Preferably, the alpha-olefins are propylene, butylene, hexane or octane, with propylene being most preferred. The block molecular weight for each of such alpha-olefin blocks typically is between about 1,000 and about 60,000.

When the A blocks are hydrogenated polymers of 1,3-cyclodiene monomers, such monomers are selected from the group consisting of 1,3-cyclohexadiene, 1,3-cycloheptadiene and 1,3-cyclooctadiene. Preferably, the cyclodiene monomer is 1,3-cyclohexadiene. Polymerization of such cyclodiene monomers is disclosed in U.S. Pat. No. 6,699,941, which disclosure is herein incorporated by reference. It will be necessary to hydrogenate the A blocks when using cyclodiene monomers since non-hydrogenated polymerized cyclodiene blocks are susceptible to sulfonation. Accordingly, after synthesis of the A block with 1,3-cyclodiene monomers, the block copolymer will be hydrogenated.

When the A blocks are hydrogenated polymers of conjugated acyclic dienes having a vinyl content less than 35 mol percent prior to hydrogenation, it is preferred that the conjugated diene is 1,3-butadiene. It is necessary that the vinyl content of the polymer prior to hydrogenation be less than 35 mol percent, preferably less than 30 mol percent. In certain embodiments, the vinyl content of the polymer prior to hydrogenation will be less than 25 mol percent, even more preferably less than 20 mol percent, and even less than 15 mol percent with one of the more advantageous vinyl contents of the polymer prior to hydrogenation being less than 10 mol percent. In this way, the A blocks will have a crystalline structure, similar to that of polyethylene. Such A block structures are disclosed in U.S. Pat. No. 3,670,054 and in U.S. Pat. No. 4,107,236, each of which disclosures is herein incorporated by reference.

The A blocks may also be polymer segments of acrylic esters or methacrylic esters. Such polymer blocks may be made according to the methods disclosed in U.S. Pat. No. 6,767,976, which disclosure is herein incorporated by reference. Specific examples of the methacrylic ester include esters of a primary alcohol and methacrylic acid, such as methyl methacrylate, ethyl methacrylate, propyl methacrylate, n-butyl methacrylate, isobutyl methacrylate, hexyl methacrylate, 2-ethylhexyl methacrylate, dodecyl methacrylate, lauryl methacrylate, methoxyethyl methacrylate, dimethylaminoethyl methacrylate, diethylaminoethyl methacrylate, glycidyl methacrylate, trimethoxysilylpropyl methacrylate, trifluoromethyl methacrylate, trifluoroethyl methacrylate; esters of a secondary alcohol and methacrylic acid, such as isopropyl methacrylate, cyclohexyl methacrylate and isobornyl methacrylate; and esters of a tertiary alcohol and methacrylic acid, such as tert-butyl methacrylate. Specific examples of the acrylic ester include esters of a primary alcohol and acrylic acid, such as methyl acrylate, ethyl acrylate, propyl acrylate, n-butyl acrylate, isobutyl acrylate, hexyl acrylate, 2-ethylhexyl acrylate, dodecyl acrylate, lauryl acrylate, methoxyethyl acrylate, dimethylaminoethyl acrylate, diethylaminoethyl acrylate, glycidyl acrylate, trimethoxysilylpropyl acrylate, trifluoromethyl acrylate, trifluoroethyl acrylate; esters of a secondary alcohol and acrylic acid, such as isopropyl acrylate, cyclohexyl acrylate and isobornyl acrylate; and esters of a tertiary alcohol and acrylic acid, such as tert-butyl acrylate. If necessary, as raw material or raw materials, one or more of other anionic polymerizable monomers may be used together with the (meth)acrylic ester. Examples of the anionic polymerizable monomer that can be optionally used include methacrylic or acrylic monomers such as trimethylsilyl methacrylate, N,N-dimethylmethacrylamide, N,N-diisopropylmethacrylamide, N,N-diethylmethacrylamide, N,N-methylethylmethacrylamide, N,N-di-tert-butylmethacrylamide, trimethylsilyl acrylate, N,N-dimethylacrylamide, N,N-di-isopropylacrylamide, N,N-methylethylacrylamide and N,N-di-tert-butylacrylamide. Moreover, there may be used a multifunctional anionic polymerizable monomer having in the molecule thereof two or more methacrylic or acrylic structures, such as methacrylic ester structures or acrylic ester structures (for example, ethylene glycol diacrylate, ethylene glycol dimethacrylate, 1,4-butanediol diacrylate, 1,4-butanediol dimethacrylate, 1,6-hexanediol diacrylate, 1,6-hexanediol dimethacrylate, trimethylolpropane triacrylate and trimethylolpropane trimethacrylate).

In the polymerization processes used to make the acrylic or methacrylic ester polymer blocks, only one of the monomers, for example, the (meth)acrylic ester may be used, or two or more thereof may be used in combination. When two or more of the monomers are used in combination, any copolymerization form selected from random, block, tapered block and the like copolymerization forms may be effected by selecting conditions such as a combination of the monomers and the timing of adding the monomers to the polymerization system (for example, simultaneous addition of two or more monomers, or separate additions at intervals of a given time).

The A blocks may also contain up to 15 mol percent of the vinyl aromatic monomers such as those present in the B blocks which are addressed in more detail in the following. In some embodiments, the A blocks may contain up to 10 mol percent, preferably they will contain only up to 5 mol percent, and particularly preferably only up to 2 mol percent of the vinyl aromatic monomers as mentioned for the B blocks. However, in the most preferred embodiments, the A blocks will contain no vinyl monomers as present in the B blocks. The sulfonation level in the A blocks may be from 0 up to 15 mol percent of the total monomers in the A block. It will be understood by those skilled in the art that suitable ranges include any combination of the specified mol percents even if the specific combination and range is not listed herewith.

The B blocks, in each case, comprises segments of one or more polymerized vinyl aromatic monomers selected from unsubstituted styrene monomer, ortho-substituted styrene monomers, meta-substituted styrene monomers, alpha-methylstyrene monomer, 1,1-diphenylethylene monomer, 1,2-diphenylethylene monomer, and mixtures thereof. In addition to the monomers and polymers mentioned above, the B blocks may also comprise a partially or completely hydrogenated copolymer of such monomer(s) with a conjugated diene selected from 1,3-butadiene, isoprene and mixtures thereof, having a vinyl content of between 20 and 80 mol percent. These copolymers with partially or completely hydrogenated dienes may be random copolymers, tapered copolymers, block copolymers or controlled distribution copolymers. In one preferred embodiment, the B blocks are selectively partially or completely hydrogenated and comprise a copolymer of conjugated dienes and the vinyl aromatic monomers noted in this paragraph. In another preferred embodiment, the B blocks are unsubstituted styrene monomer blocks which are saturated by virtue of the nature of the monomer and do not require the added process step of hydrogenation. The B blocks having a controlled distribution structure are disclosed in U.S. Pat. No. 7,169,848, which disclosure is herein incorporated by reference. U.S. Pat. No. 7,169,848 also discloses the preparation of sulfonated block copolymers. The B blocks comprising a styrene block are described herein. In a preferred embodiment, the B blocks are made up of unsubstituted styrene and will not require a separate hydrogenation step.

In another aspect of the present disclosure, the block copolymer includes at least one impact modifier block D having a glass transition temperature less than 20° C. In one embodiment, the impact modifier block D comprises a hydrogenated polymer or copolymer of a conjugated diene selected from isoprene, 1,3-butadiene and mixtures thereof the butadiene portion of the polymer block having a vinyl content prior to hydrogenation of between 20 and 80 mol percent and the polymer block having a number average molecular weight of between 1,000 and 50,000. In another embodiment, the impact modifier block D comprises an acrylate or silicone polymer having a number average molecular weight of 1,000 to 50,000. In still another embodiment, the impact modifier block D block is a polymer block of isobutylene having a number average molecular weight of 1,000 to 50,000.

Each A block independently has a number average molecular weight between about 1,000 and about 60,000 and each B block independently has a number average molecular weight between about 10,000 and about 300,000. Preferably each A block has a number average molecular weight of between 2,000 and 50,000, more preferably between 3,000 and 40,000 and even more preferably between 3,000 and 30,000. Preferably each B block has a number average molecular weight of between 15,000 and 250,000, more preferably between 20,000 and 200,000, and even more preferably between 30,000 and 100,000. It will be understood by those skilled in the art that suitable ranges include any combination of the specified number average molecular weights even if the specific combination and range is not listed herewith. These molecular weights are most accurately determined by light scattering measurements, and are expressed as number average molecular weight. Preferably, the sulfonated polymers have from about 8 mol percent to about 80 mol percent, preferably from about 10 to about 60 mol percent A blocks, more preferably more than 15 mol percent A blocks and even more preferably from about 20 to about 50 mol percent A blocks.

The relative amount of vinyl aromatic monomers which are unsubstituted styrene monomer, ortho-substituted styrene monomer, meta-substituted styrene monomer, alpha-methylstyrene monomer, 1,1-diphenylethylene monomer, and 1,2-diphenylethylene monomer in the sulfonated block copolymer is from about 5 to about 90 mol percent, preferably from about 5 to about 85 mol percent. In alternative embodiments, the amount is from about 10 to about 80 mol percent, preferably from about 10 to about 75 mol percent, more preferably from about 15 to about 75 mol percent, with the most preferred being from about 25 to about 70 mol percent. It will be understood by those skilled in the art that suitable ranges include any combination of the specified mol percents even if the specific combination is not listed herewith.

In a preferred embodiment, the mol percent of vinyl aromatic monomers which are unsubstituted styrene monomer, ortho-substituted styrene monomer, meta-substituted styrene monomer, alpha-methylstyrene monomer, 1,1-diphenylethylene monomer, and 1,2-diphenylethylene monomer in each B block is from about 10 to about 100 mol percent, preferably from about 25 to about 100 mol percent, more preferably from about 50 to about 100 mol percent, even more preferably from about 75 to about 100 mol percent and most preferably 100 mol percent. It will be understood by those skilled in the art that suitable ranges include any combination of the specified mol percents even if the specific combination and range is not listed herewith.

Typical levels of sulfonation are such that each B block contains one or more sulfonic functional groups. Preferred levels of sulfonation are 10 to 100 mol percent based on the mol percent of vinyl aromatic monomers which are unsubstituted styrene monomer, ortho-substituted styrene monomer, meta-substituted styrene monomer, alpha-methylstyrene monomer, 1,1-diphenylethylene monomer, and 1,2-diphenylethylene monomer in each B block, more preferably about 20 to 95 mol percent and even more preferably about 30 to 90 mol percent. It will be understood by those skilled in the art that suitable ranges of sulfonation include any combination of the specified mol percents even if the specific combination and range is not listed herewith. The level of sulfonation is determined by titration of a dry polymer sample, which has been re-dissolved in tetrahydrofuran with a standardized solution of NaOH in a mixed alcohol and water solvent.

3. Overall Anionic Process to Prepare Polymers

The anionic polymerization process comprises polymerizing the suitable monomers in solution with a lithium initiator. The solvent used as the polymerization vehicle may be any hydrocarbon that does not react with the living anionic chain end of the forming polymer, is easily handled in commercial polymerization units, and offers the appropriate solubility characteristics for the product polymer. For example, non-polar aliphatic hydrocarbons, which are generally lacking in ionizable hydrogen atoms make particularly suitable solvents. Frequently used are cyclic alkanes, such as cyclopentane, cyclohexane, cycloheptane, and cyclooctane, all of which are relatively non-polar. Other suitable solvents will be known to those skilled in the art and can be selected to perform effectively in a given set of process conditions, with polymerization temperature being one of the major factors taken into consideration.

Starting materials for preparing the block copolymers of the present disclosure include the initial monomers noted above. Other important starting materials for anionic copolymerizations include one or more polymerization initiators. In the present disclosure suitable initiators include, for example, alkyl lithium compounds such as s-butyllithium, n-butyllithium, t-butyllithium, amyllithium and the like and other organo lithium compounds including di-initiators such as the di-sec-butyl lithium adduct of m-diisopropenyl benzene. Other such di-initiators are disclosed in U.S. Pat. No. 6,492,469, the disclosure of which is incorporated herein by reference. Of the various polymerization initiators, s-butyllithium is preferred. The initiator can be used in the polymerization mixture (including monomers and solvent) in an amount calculated on the basis of one initiator molecule per desired polymer chain. The lithium initiator process is well known and is described in, for example, U.S. Pat. No. 4,039,593 and U.S. Pat. No. Re. 27,145, the disclosure of each of which is incorporated herein by reference.

Polymerization conditions to prepare the block copolymers of the present disclosure are typically similar to those used for anionic polymerizations in general. The polymerization is preferably carried out at a temperature of from about −30° C. to about 150° C., more preferably about 10° C. to about 100° C., and most preferably, in view of industrial limitations, from about 30° C. to about 90° C. The polymerization is carried out in an inert atmosphere, preferably under nitrogen, and may also be accomplished under pressure within the range of from about 0.5 to about 10 bars. This copolymerization generally requires less than about 12 hours, and can be accomplished in from about 5 minutes to about 5 hours, depending upon the temperature, the concentration of the monomer components, and the molecular weight of the polymer that is desired. When two or more of the monomers are used in combination, any copolymerization form selected from random, block, tapered block, controlled distribution block, and the like copolymerization forms may be utilized.

It will be understood by those skilled in the art that the anionic polymerization process may be moderated by the addition of a Lewis acid, such as an aluminum alkyl, a magnesium alkyl, a zinc alkyl or combinations thereof. The effects of the added Lewis acid on the polymerization process are
1) to lower the viscosity of the living polymer solution allowing for a process that operates at higher polymer concentrations and thus uses less solvent,
2) to enhance the thermal stability of the living polymer chain end which permits polymerization at higher temperatures and again, reduces the viscosity of the polymer solution allowing for the use of less solvent, and
3) to slow the rate of reaction which permits polymerization at higher temperatures while using the same technology for removing the heat of reaction as had been used in the standard anionic polymerization process.

The processing benefits of using Lewis acids to moderate anionic polymerization techniques have been disclosed in U.S. Pat. No. 6,391,981, U.S. Pat. No. 6,455,651 and U.S. Pat. No. 6,492,469, the disclosure of each of which is herein incorporated by reference. Related information is disclosed in U.S. Pat. No. 6,444,767 and U.S. Pat. No. 6,686,423, the disclosure of each of which is incorporated herein by reference. The polymer made by such a moderated, anionic polymerization process can have the same structure as one prepared using the conventional anionic polymerization process and as such, this process can be useful in making the polymers of the present disclosure. For Lewis acid moderated, anionic polymerization processes, reaction temperatures between 100° C. and 150° C. are preferred as at these temperatures it is possible to take advantage of conducting the reaction at very high polymer concentrations. While a stoichiometric excess of the Lewis acid may be used, in most instances there is not sufficient benefit in improved processing to justify the additional cost of the excess Lewis acid. It is preferred to use from about 0.1 to about 1 mole of Lewis acid per mole of living, anionic chain ends to achieve an improvement in process performance with the moderated, anionic polymerization technique.

Preparation of radial (branched) polymers requires a post-polymerization step called “coupling”. In the above radial formulas n is an integer of from 3 to about 30, preferably from about 3 to about 15, and more preferably from 3 to 6, and X is the remnant or residue of a coupling agent. A variety of coupling agents is known in the art and can be used in preparing the block copolymers. These include, for example, dihaloalkanes, silicon halides, siloxanes, multifunctional epoxides, silica compounds, esters of monohydric alcohols with carboxylic acids, (e.g. methylbenzoate and dimethyl adipate) and epoxidized oils. Star-shaped polymers are prepared with polyalkenyl coupling agents as disclosed in, for example, U.S. Pat. No. 3,985,830, U.S. Pat. No. 4,391,949 and U.S. Pat. No. 4,444,953; as well as CA 716,645, the disclosure of each of which is incorporated herein by reference. Suitable polyalkenyl coupling agents include divinylbenzene, and preferably m-divinylbenzene. Preferred are tetra-alkoxysilanes such as tetra-methoxysilane (TMOS) and tetra-ethoxysilane (TEOS), tri-alkoxysilanes such as methyltrimethoxysilane (MTMS), aliphatic diesters such as dimethyl adipate and diethyl adipate, and diglycidyl aromatic epoxy compounds such as diglycidyl ethers deriving from the reaction of bis-phenol A and epichlorohydrin.

Linear polymers may also be prepared by a post-polymerization “coupling” step. However, unlike radial polymers, “n” in the above formulas is the integer 2, and X is the remnant or residue of a coupling agent.

4. Process to Prepare Hydrogenated Block Copolymers

As noted, in some cases—i.e., (1) when there is a diene in the B interior blocks, (2) when the A block is a polymer of a 1,3-cyclodiene, (3) when there is an impact modifier block D and (4) when the A block is a polymer of a conjugated diene having a vinyl content of less than 35 mol percent—it is necessary to selectively hydrogenate the block copolymer to remove any ethylenic unsaturation prior to sulfonation. Hydrogenation generally improves thermal stability, ultraviolet light stability, oxidative stability, and, therefore, weatherability of the final polymer, and reduces the risk of sulfonating the A block or the D block.

Hydrogenation can be carried out via any of the several hydrogenation or selective hydrogenation processes known in the prior art. Such hydrogenation has been accomplished using methods such as those taught in, for example, U.S. Pat. No. 3,595,942, U.S. Pat. No. 3,634,549, U.S. Pat. No. 3,670,054, U.S. Pat. No. 3,700,633, and U.S. Pat. No. Re. 27,145, the disclosure of each of which is incorporated herein by reference. These methods operate to hydrogenate polymers containing ethylenic unsaturation and are based upon operation of a suitable catalyst. Such a catalyst, or catalyst precursor, preferably comprises a Group 8 to 10 metal such as nickel or cobalt which is combined with a suitable reducing agent such as an aluminum alkyl or hydride of a metal selected from Groups 1, 2 and 13 of the Periodic Table of the Elements, particularly lithium, magnesium or aluminum. This preparation can be accomplished in a suitable solvent or diluent at a temperature from about 20° C. to about 80° C. Other catalysts that are useful include titanium based catalyst systems.

Hydrogenation can be carried out under such conditions that at least about 90 percent of the conjugated diene double bonds are reduced, and between zero and 10 percent of the arene double bonds are reduced. Preferred ranges are at least about 95 percent of the conjugated diene double bonds reduced, and more preferably about 98 percent of the conjugated diene double bonds are reduced.

Once the hydrogenation is complete, it is preferable to oxidize and extract the catalyst by stifling the polymer solution with a relatively large amount of aqueous acid (preferably 1 to 30 percent by weight acid), at a volume ratio of about 0.5 parts aqueous acid to 1 part polymer solution. The nature of the acid is not critical. Suitable acids include phosphoric acid, sulfuric acid and organic acids. This stifling is continued at about 50° C. for from about 30 to about 60 minutes while sparging with a mixture of oxygen and nitrogen. Care must be exercised in this step to avoid that an explosive mixture of oxygen and hydrocarbons is formed.

5. Process to Make Sulfonated Polymers

According to the multiple embodiments disclosed herein, the above prepared block copolymers are sulfonated to obtain a sulfonated polymer product that is in solution and in micellar form. In this micellar form, the sulfonated block copolymer can be neutralized prior to casting a membrane, and at the same time, the risk of gelling and/or precipitation of the sulfonated block copolymer while in solution is reduced.

Without being bound by any particular theory, it is the present belief that the micelle structure of the sulfonated block copolymer can be described as having a core comprising the sulfonated block or blocks having a substantial amount of spent sulfonating agent residues which is surrounded by the sulfonation resistant block or blocks which, in turn, are swollen by an organic non-halogenated aliphatic solvent. As will be further described in more detail below, the sulfonated blocks are highly polar due to the presence of sulfonic acid and/or sulfonate ester functional groups. Accordingly, such sulfonated blocks are sequestered into a core, while the outer sulfonation resistant blocks form a shell which is solvated by a non-halogenated aliphatic solvent. In addition to forming discrete micelles, there may also be formation of polymer aggregates. Without being bound by any particular theory, polymer aggregates can be described as discrete or non-discrete structures resulting from association of polymer chains in ways other than the description provided for micelles, and/or loosely aggregated groups of two or more discrete micelles. Accordingly, the solvated sulfonated block copolymer in micellar form may include discrete micelles and/or aggregates of micelles, with such solution optionally including aggregated polymer chains having structures other than the micelle structure.

Micelles can be formed as a result of the sulfonation process, or alternatively, the block copolymer may arrange in a micelle structure prior to sulfonation.

In some embodiments, for the formation of micelles, the sulfonation processes as described in WO 2008/089332 may be employed. The methods are useful for preparing sulfonated styrenic block copolymers as described in U.S. Pat. No. 7,737,224.

After polymerization, the polymer can be sulfonated using a sulfonation reagent such as an acyl sulfate in at least one non-halogenated aliphatic solvent. In some embodiments, the precursor polymer can be sulfonated after being isolated, washed, and dried from the reaction mixture resulting from the production of the precursor polymer. In some other embodiments, the precursor polymer can be sulfonated without being isolated from the reaction mixture resulting from the production of the precursor polymer.

(i) Solvent

The organic solvent is preferably a non-halogenated aliphatic solvent and contains a first non-halogenated aliphatic solvent which serves to solvate one or more of the sulfonation resistant blocks or non-sulfonated blocks of the copolymer. The first non-halogenated aliphatic solvent may include substituted or unsubstituted cyclic aliphatic hydrocarbons having from about 5 to 10 carbons. Non-limiting examples include cyclohexane, methylcyclohexane, cyclopentane, cycloheptane, cyclooctane and mixtures thereof. The most preferable solvents are cyclohexane, cyclopentane and methylcyclohexane. The first solvent may also be the same solvent used as the polymerization vehicle for anionic polymerization of the polymer blocks.

In some embodiments, the block copolymer may be in micellar form prior to sulfonation even in the case of using only a first solvent. The addition of a second non-halogenated aliphatic solvent to a solution of the precursor polymer in the first non-halogenated aliphatic solvent can result in or assist the “pre-formation” of polymer micelles and/or other polymer aggregates. The second non-halogenated solvent, on the other hand, is preferably chosen such that it is miscible with the first solvent, but is a poor solvent for the sulfonation susceptible block of the precursor polymer in the process temperature range and also does not impede the sulfonation reaction. In other words, preferably, the sulfonation susceptible block of the precursor polymer is substantially insoluble in the second non-halogenated solvent in the process temperature range. In the case where the sulfonation susceptible block of the precursor polymer is polystyrene, suitable solvents which are poor solvents for polystyrene and can be used as the second non-halogenated solvent include linear and branched aliphatic hydrocarbons of up to about 12 carbons, for example, hexane, heptane, octane, 2-ethyl hexane, isooctane, nonane, decane, paraffinic oils, mixed paraffinic solvents, and the like. One preferred example of the second non-halogenated aliphatic solvent is n-heptane.

The pre-formed polymer micelles and/or other polymer aggregates allow the sulfonation of the polymer to proceed essentially without disabling gelling at considerably higher concentration than can be achieved without the addition of the second solvent. In addition, this approach can substantially improve the utility of more polar acyl sulfates, such as C₃ acyl sulfate (propionyl sulfate), in terms of polymer sulfonation conversion rate and minimization of by-products. In other words, this approach may improve the utility of more polar sulfonation reagents. Such acyl sulfates are further described below.

(ii) Polymer Concentration

In accordance with some embodiments, high levels of styrene sulfonation can be achieved in a manner that is substantially free of polymer precipitation and free of disabling gelling in the reaction mixture, the reaction product, or both, by maintaining the precursor polymer concentration below a limiting concentration of the precursor polymer, at least during the early stages of sulfonation. It will be understood by those skilled in the art that minor amounts of polymers may deposit on surfaces as a result of localized solvent evaporation in the course of processing in a mixture that is substantially free of polymer precipitation. For example, in accordance with some embodiments, a mixture is considered to be substantially free of polymer precipitation when no more than 5% of the polymer in the mixture has precipitated.

The polymer concentration at which the sulfonation can be conducted depends upon the composition of the starting polymer, since the limiting concentration below which polymer gelling is non-disabling or negligible depends upon the polymer composition. As stated above, the limiting concentration may also be dependent on other factors such as the identity of the solvent or the solvent mixture used and the desired degree of sulfonation. Generally, the polymer concentration falls within the range of from about 1%-wt. to about 30%-wt., alternatively from about 1%-wt. to about 20%-wt., alternatively from about 1%-wt. to about 15%-wt., alternatively from about 1%-wt. to about 12%-wt., or alternatively from about 1%-wt. to about 10%-wt., based on the total weight of a reaction mixture that is preferably substantially free of halogenated solvents. It will be understood by those skilled in the art that suitable ranges include any combination of the specified mol percents even if the specific combination and range is not listed herewith.

In accordance with some embodiments of the presently described technology, the initial concentration of the precursor block polymer or mixture of precursor block polymers should be maintained below the limiting concentration of the precursor polymer(s), alternatively in the range of from about 0.1%-wt. to a concentration that is below the limiting concentration of the precursor polymer(s), alternatively from about 0.5%-wt. to a concentration that is below the limiting concentration of the precursor polymer(s), alternatively from about 1.0%-wt. to a concentration that is about 0.1%-wt. below the limiting concentration of the precursor polymer(s), alternatively from about 2.0%-wt. to a concentration that is about 0.1%-wt. below the limiting concentration of the precursor polymer(s), alternatively from about 3.0%-wt. to a concentration that is about 0.1%-wt. below the limiting concentration of the precursor polymer(s), alternatively from about 5.0%-wt. to a concentration that is about 0.1%-wt. below the limiting concentration of the precursor polymer(s), based on the total weight of the reaction mixture. It will be understood by those skilled in the art that suitable ranges include any combination of the specified wt % even if the specific combination and range is not listed herewith.

At least in some embodiments, maintaining the polymer concentration below the limiting concentration can result in reaction mixtures with reduced concentrations of by-product carboxylic acid relative to the higher concentration conditions that lead to gelling.

It will be understood by those skilled in the art, however, that during the production of the sulfonated polymer in some embodiments of the present technology, especially in a semi-batch or continuous production process, the total concentration of the polymer(s) in the reaction mixture may be above the limiting concentration of the precursor polymer.

(iii) Sulfonation Agent

According to multiple embodiments, acyl sulfate may be used for sulfonating the polymerized block copolymer. The acyl group preferably is derived from a C₂ to C₈, alternatively C₃ to C₈, alternatively C₃ to C₅, linear, branched, or cyclic carboxylic acid, anhydride, or acid chloride, or mixtures thereof. Preferably, these compounds do not contain non-aromatic carbon-carbon double bonds, hydroxyl groups, or any other functionality that is reactive with acyl sulfate or decomposes readily under sulfonation reaction conditions. For example, acyl groups that have aliphatic quaternary carbons in the alpha-position from the carbonyl functionality (e.g., acyl sulfate derived from trimethylacetic anhydride) appear to decompose readily during polymer sulfonation reaction, and preferably should be avoided in the presently described technology. Also included in the scope of useful acyl groups for the generation of acyl sulfate in the present technology are those derived from aromatic carboxylic acids, anhydrides, and acid chlorides such as benzoic and phthalic anhydride. More preferably, the acyl group is selected from the group of acetyl, propionyl, n-butyryl, and isobutyryl. Even more preferably, the acyl group is isobutyryl. It has been discovered that isobutyryl sulfate can afford high degrees of polymer sulfonation and relatively minimal by-product formation.

The formation of acyl sulfate from a carboxylic anhydride and sulfuric acid can be represented by the following reaction:

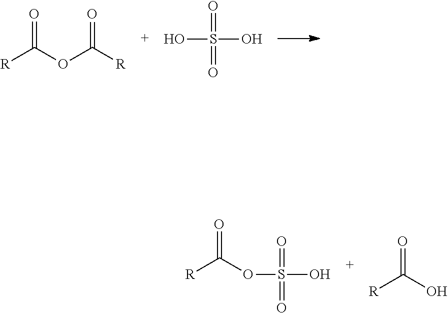

Acyl sulfates are subject to slow decomposition during the course of sulfonation reactions forming alpha-sulfonated carboxylic acids of the following formula:

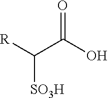

In one embodiment of the presently described technology, the acyl sulfate reagent is obtained from a carboxylic anhydride and sulfuric acid in a reaction that is conducted in a separate “pre-generation” reaction prior to addition to a solution of polymer in a non-halogenated aliphatic solvent. The pre-generation reaction can be conducted with or without a solvent. When a solvent is used to pre-generate the acyl sulfate, the solvent is preferably non-halogenated. Alternatively, the acyl sulfate reagent can be obtained in an in-situ reaction within a solution of the polymer in a non-halogenated aliphatic solvent. In accordance with this embodiment of the present technology, the molar ratio of anhydride to sulfuric acid can be from about 0.8 to about 2, and preferably from about 1.0 to about 1.4. The sulfuric acid used in this preferred method preferably has a concentration of about 93% to about 100% and more preferably has a concentration of about 95% to about 100%, by weight. It will be understood by those skilled in the art that oleum may be used as an alternative to sulfuric acid in an in-situ reaction to generate acyl sulfate, provided that the oleum strength is sufficiently low so as to avoid or minimize unintended charring of the reaction mixture.

In another embodiment of the present technology, the acyl sulfate reagent can be obtained from a carboxylic anhydride and oleum in a reaction that is conducted in a separate “pre-generation” reaction prior to addition to a solution of polymer in aliphatic solvent, wherein the oleum strength is in the range of from about 1% to about 60% free sulfur trioxide, alternatively from about 1% to about 46% free sulfur trioxide, alternatively from about 10% to about 46% free sulfur trioxide, and wherein the molar ratio of anhydride to sulfuric acid present in the oleum is from about 0.9 to about 1.2.

Additionally, the acyl sulfate reagent can be prepared from a carboxylic anhydride via reaction with any combination of sulfuric acid, oleum, or sulfur trioxide. Further, the acyl sulfate reagent can be prepared from a carboxylic acid via reaction with chlorosulfonic acid, oleum, sulfur trioxide, or any combination thereof. Moreover, the acyl sulfate reagent can also be prepared from a carboxylic acid chloride via reaction with sulfuric acid. Alternatively, the acyl sulfate may be prepared from any combination of carboxylic acid, anhydride, and/or acid chloride.

The sulfonation of polymer styrenic repeat units with the acyl sulfate can be represented by the following reaction:

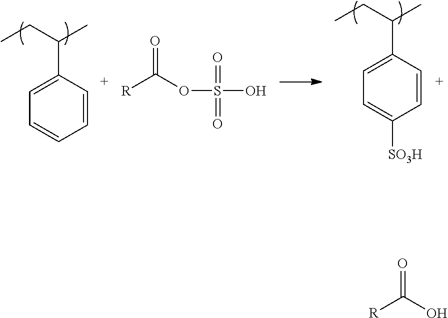

The acyl sulfate reagent that may be used relative to the moles of sulfonation susceptible monomer repeat units present in the polymer solution in amounts ranging from very low levels for lightly sulfonated polymer products to high levels for heavily sulfonated polymer products. The molar amount of the acyl sulfate can be defined as the theoretical amount of the acyl sulfate that can be generated from a given method, the amount being dictated by the limiting reagent in the reaction. The molar ratio of acyl sulfate to styrene repeat units (i.e., sulfonation susceptible units) in accordance with some embodiments of the present technology may range from about 0.1 to about 2.0, alternatively from about 0.2 to about 1.3, alternatively from about 0.3 to about 1.0.

In accordance with at least some embodiments of the presently described technology, the degree of sulfonation of the vinyl aromatic monomers susceptible to sulfonation in the block polymers is greater than about 0.4 milliequivalents (meq) sulfonic acid per gram sulfonated polymer (0.4 meq/g), alternatively greater than about 0.6 meq sulfonic acid per gram sulfonated polymer (0.6 meq/g), alternatively greater than about 0.8 meq sulfonic acid per gram sulfonated polymer (0.8 meq/g), alternatively greater than about 1.0 meq sulfonic acid per gram sulfonated polymer (1.0 meq/g), alternatively greater than about 1.4 meq sulfonic acid per gram sulfonated polymer (1.4 meq/g). For example, after the precursor polymers described above are sulfonated in accordance with the methods of the presently described technology, the typical levels of sulfonation are where each B block contains one or more sulfonic functional groups. Preferred levels of sulfonation are from about 10 to about 100 mol percent, alternatively from about 20 to 95 mol percent, alternatively from about 30 to 90 mol percent, and alternatively from about 40 to about 70 mol percent, based on the mol percent of sulfonation susceptible vinyl aromatic monomers in each B block, which can be, for example, unsubstituted styrene monomer, ortho-substituted styrene monomer, meta-substituted styrene monomer, alpha-methylstyrene monomer, 1,1-diphenyl ethylene monomer, 1,2-diphenyl ethylene monomer, a derivative thereof, or a mixture thereof. It will be understood by those skilled in the art that suitable ranges of sulfonation level include any combination of the specified mol percents even if the specific combination and range is not listed herewith.

The level or degree of sulfonation of a sulfonated polymer can be measured by NMR and/or titration methods as known to people skilled in the art, and/or a method using two separate titrations as described in the Examples below and may be appreciated by people skilled in the art. For example, a resulting solution from the methods of the present technology can be analyzed by ¹H-NMR at about 60° C. (±20° C.). The percentage styrene sulfonation can be calculated from the integration of aromatic signals in the ¹H-NMR spectrum. For another example, the reaction product can be analyzed by two separate titrations (the “two-titration method”) to determine the levels of styrenic polymer sulfonic acid, sulfuric acid, and non-polymeric by-product sulfonic acid (e.g. 2-sulfo-alkylcarboxylic acid), and then to calculate the degree of styrene sulfonation based on mass balance. Alternatively, the level of sulfonation can be determined by titration of a dry polymer sample, which has been re-dissolved in tetrahydrofuran with a standardized solution of NaOH in a mixture of alcohol and water. In the latter case, rigorous removal of by-product acids are preferably ensured.

Although embodiments for sulfonating polymers are described above in the context of acyl sulfate reagents, the utility of other sulfonation reagents are also contemplated. For example, the use of those sulfonation reagents derived from complexing/reacting sulfur trioxides and phosphate esters such as triethylphosphate has been demonstrated in the present technology. The chemistry of such sulfonation reagents is known in the art to afford aromatic sulfonation with significant degrees of sulfonic acid alkyl ester incorporation. As such, the resultant sulfonated polymers likely contain both sulfonic acid and sulfonic acid alkyl ester groups. Other contemplated sulfonation reagents include, but are not limited to, those derived from the reaction or complexation of sulfur trioxide with phosphorus pentoxide, polyphosphoric acid, 1,4-dioxane, triethylamine, etc.

(iv) Reaction Conditions

The sulfonation reaction between the acyl sulfates and sulfonation susceptible block copolymers such as aromatic-containing polymers (e.g., styrenic block copolymers) can be conducted at a reaction temperature in the range of from about 20° C. to about 150° C., alternatively from about 20° C. to about 100° C., alternatively from about 20° C. to about 80° C., alternatively from about 30° C. to about 70° C., alternatively from about 40° C. to about 60° C. (e.g., at about 50° C.). The reaction time can be in the range of from approximately less than 1 minute to approximately 24 hours or longer, dependent on the temperature of the reaction. In some preferred acyl sulfate embodiments that utilize in-situ reaction of carboxylic anhydride and sulfuric acid, the initial temperature of the reaction mixture can be about the same as the intended sulfonation reaction temperature. Alternatively, the initial temperature may be lower than the intended subsequent sulfonation reaction temperature. In a preferred embodiment, the acyl sulfate can be generated in-situ at about 20° C. to about 40° C. (e.g., at about 30° C.) for about 0.5 to about 2 hours, alternatively about 1 to about 1.5 hours, and then the reaction mixture can be heated to about 40° C. to about 60° C. to expedite the completion of the reaction.

Although not required, an optional reaction quenching step can be conducted through the addition of a quenching agent, which can be, for example, water or hydroxyl-containing compounds such as methanol, ethanol, or isopropanol. Typically in such a step, an amount of the quenching agent at least sufficient to react with residual unreacted acyl sulfate may be added.

In some embodiments of the presently described technology, the sulfonation of the aromatic-containing polymer in a non-halogenated aliphatic solvent can be carried out by contacting the aromatic-containing polymer with a sulfonation reagent in a batch reaction or a semi-batch reaction. In some other embodiments of the present technology, the sulfonation can be carried out in a continuous reaction, which can be enabled, for example, through the use of a continuous stirred tank reactor or a series of two or more continuous stirred tank reactors.

As a result of sulfonation, the micelle cores contain sulfonation susceptible blocks having sulfonic acid and/or sulfonate ester functionality which are surrounded by an outer shell containing sulfonation resistant blocks of the block copolymer. The driving force for this phase segregation (causing the micelle formation) in solution has been attributed to the considerable difference in polarity between the sulfonated block(s) and the non-sulfonated blocks of the sulfonated block copolymer. The latter blocks are freely solvable by a non-halogenated aliphatic solvent, for example the first solvent disclosed above. On the other hand, the sulfonated polymer block(s) may arrange to concentrate in the core of micelle.

(v) Additional Components

Further, the copolymers disclosed herein can be compounded with other components not adversely affecting the copolymer properties or the membrane formed from the sulfonated block copolymer.

(vi) Film or Membrane Casting

Once the sulfonation reaction is completed, the block copolymers can be cast directly into a film without the necessity of isolating the block copolymer.

Conventional methods may be used for casting the polymer to form a film. One method used may be referred to as solution casting. According to this procedure, the sulfonated copolymer solution obtained from the sulfonation reaction as described above may be poured onto an inert substrate such as a siliconized glass plate. Excess solution can be removed with a glass rod. The remaining solution is then allowed to dry completely until the solvent has been evaporated thereby leaving a cast film of the sulfonated copolymer. In this particular embodiment the polymeric film (e.g., membrane) can be submerged in water and will retain its form (solid) while in the water. In other words, the block copolymer will not dissolve in water or disperse in water.

### Coating Methods

In a further aspect, the present disclosure pertains to a process for making an article comprising a substrate which comprises:

preparing a solution or dispersion containing a sulfonated hydrocarbon polymer and at least one solvent, and

coating the solution or dispersion on at least one surface of the substrate in an interrupted pattern such that at least 10% to about 80% of the substrate surface remains uncoated.

In particular embodiments, the sulfonated hydrocarbon polymer is the sulfonated block copolymer addressed hereinbefore.

In particular, the sulfonated block copolymer can be applied to the surface of a substrate as a solution, dispersion or emulsion. For convenience sake, the solutions, dispersions or emulsions employed in the various embodiments of the coating method hereinafter may collectively be referred to as ‘solutions’. Correspondingly, the reference to a solvent is used collectively for solvents, i.e., liquids and liquid mixtures capable of dissolving the sulfonated hydrocarbon polymer, and for dispersants, i.e., liquids and liquid mixtures capable of dispersing the sulfonated hydrocarbon polymer.

1. Coating Solution

In some embodiments, subsequent to sulfonation, the sulfonated block copolymer in solution can be applied to a fabric in a desired pattern and subsequently dried to provide a coating having an interrupted pattern. Depending on the coating process employed, the solids content and viscosity can be adjusted to obtain optimal coating of the fabric. For example, solvent can be added or evaporated to obtain desired levels of solids content and viscosity. The sulfonated block copolymer can then be applied to a fabric from solution without having to cast the film or forming an interrupted membrane.

However in some embodiments, the coating process may have requirements in viscosity and solids content which necessitate that the solvent differs from that employed during sulfonation. Accordingly, in such embodiments the isolated sulfonated block copolymer is re-dissolved into a suitable solvent for applying the sulfonated block copolymer to a fabric. This allows tailoring the solvent and various conditions to optimize the solution for any particular fabric coating process. Various factors may influence the choice of solvent, for example the boiling point of the solvent, solids content, viscosity (with the dissolved polymer), cost, and ease of use are among factors for consideration.

As an initial consideration, the same solvents employed for making sulfonated block copolymers can be employed also for re-dissolving the sulfonated block copolymer film, however it may be necessary to use combinations of solvents for this result (for example with respect to cyclohexane). However, generally one or more non-polar solvents can be employed including aliphatic solvents, which may include substituted or unsubstituted cyclic or acyclic, linear or branched aliphatic hydrocarbons having from about 5 to 12 carbons. Additionally, substituted or unsubstituted aryl hydrocarbons having from 6 to 10 carbons may also be employed.

Accordingly, suitable non-polar solvents can be selected from pentanes, hexanes, heptanes, octanes, cyclohexane, methylcyclohexane, cyclopentane, cycloheptane, cyclooctane, triethylbenzene, isopentane, and cyclopentane, toluene, benzene, xylene, and mesitylene with toluene and cyclohexane being the most preferred non-polar solvents. Mixtures of the aforementioned solvents can also be employed.

One or more polar solvents can also be employed and can be selected from alcohols having from 1 to 20 carbon atoms, preferably from 1 to 8 carbon atoms, more preferably from 1 to 5 carbon atoms; ethers having from 1 to 20 carbon atoms, preferably from 1 to 8 carbon atoms, more preferably from 1 to 4 carbon atoms, including cyclic ethers; esters of carboxylic acids, esters of sulfuric acid, amides, carboxylic acids, anhydrides, sulfoxides, nitriles, and ketones having from 1 to 20 carbon atoms, preferably from 1 to 8 carbon atoms, more preferably from 1 to 4 carbon atoms, including cyclic ketones.

Additionally, polar solvents can be employed selected from methanol, ethanol, propanol, isopropanol, dimethyl ether, diethyl ether, dipropyl ether, dibutyl ether, substituted and unsubstituted furans, oxetane, dimethyl ketone, diethyl ketone, methyl ethyl ketone, substituted and unsubstituted tetrahydrofuran (THF), methyl acetate, ethyl acetate, propyl acetate, methylsulfate, dimethylsulfate, carbon disulfide, formic acid, acetic acid, sulfoacetic acid, acetic anhydride, acetone, cresol, creosol, dimethylsulfoxide (DMSO), cyclohexanone, dimethyl acetamide, dimethyl formamide, acetonitrile, water and dioxane, with THF and alcohols being the more preferred of the polar solvents.

A mixture of non-polar and polar solvents can be employed. For example toluene and a C₁ to C₆, or alternatively a C₂ to C₅ alcohol can be employed, such as toluene/ethanol, toluene/propanol, toluene/butanol, and toluene/pentanol. This can be referred to as a toluene based system. Additionally, there can be THF based solvent system, such as THF/ethanol, THF/propanol, THF/butanol, or THF/pentanol.

The choice of the solvent system can depend on the method for applying the sulfonated block copolymer solution to the fabric. For example, if the solvent is contained and handled in an uncovered process then a solvent with lower volatility is desirable. In uncovered processes, the solvent may vaporize to the extent that the viscosity cannot be maintained at a reasonable level.

Accordingly, in uncovered processes where the solvent is exposed to the air, a solvent with a higher boiling point is preferable. In such systems a toluene based system, and in particular a Toluene/alcohol such as Toluene/1-pentanol is a preferred solvent. However, in a covered system, where volatilization is less an issue, THF based system can be successfully employed, in particular a THF/alcohol such as THF/ethanol. The viscosity of the solution should be at a level which enables coating of the fabric with the sulfonated block copolymer solution. The viscosity should be low enough to allow for coating and attachment of the sulfonated block copolymer to the fabric, but not so high that the coating process is inhibited. Accordingly, viscosity can range from 500 to 12,000 cps, and more preferably 1,000 to 10,000 cps, more preferably from 2,000 to 8,000 cps, more preferably from 2,000 to 4,000 cps. In some embodiments, the viscosity should be below 12,000 cps, alternatively below 6,000 cps, alternatively below 4,000 cps. However, some coating processes may require higher or lower viscosities. Preferably, the coating viscosity will be high enough to maintain a majority of the sulfonated block copolymer at or near the coated surface but low enough to allow for appropriate bonding to the substrate.

An additional consideration is solids content. Solids content can affect the process as well as the effectiveness of the cooling properties once the block copolymer is coated onto a fabric. One useful comparison is the degree of cooling that a cast sulfonated block copolymer film has when a drop of water is placed thereon, or is water saturated. Preferably, the sulfonated block copolymer once coated on a fabric should have the same or similar degree of cooling action as the cast film by itself.

Solids content should be high enough to deposit a sufficient amount of sulfonated block copolymer on the fabric to enable cooling. Accordingly, the solids content can be from 1 to 35 wt %, alternatively from 5 to 30 wt %, alternatively from 8 to 30 wt %, alternatively from 15 to 30 wt %, alternatively from 20 to 28 wt %. The type of solvent chosen can affect the solids level content that can be achieved.

Accordingly, among the considerations regarding the solvent employed includes volatility, viscosity, and solids content and the success of employment can depend on the coating process used, for example, whether covered or uncovered, how fast or slow the process is.

In addition to solution coating, the cast sulfonated block copolymer film can be laminated onto the fabric. This can be done via thermal lamination or by use of adhesives. Thermal lamination can be conducted by applying the film to a fabric under heat and optionally under pressure as well. A plate press can be suitably employed or by a roller assembly or calendaring process known in the art for applying a film to a substrate such as a fabric.

Generally with the aforementioned solvents, the sulfonated block copolymer will completely dissolve in solution. However, in some solvents, the block copolymer may not fully dissolve. In such cases, the block copolymer maybe chopped or cut and then dispersed in the solvent in such manner. In addition to the above however, aqueous dispersions can be prepared. The sulfonated block copolymer disclosed herein is itself non-dispersable and non-dissolvable in water without specific additional processing. With respect to such processing, it can be cut or ground into smaller pieces and mixed with water. When sufficiently small, it can in this way be “dispersed” in the aqueous medium to form what is termed for purposes herein as a “dispersion.” This type of dispersion can also be achieved through the use of surfactants. An alternative method includes adding a non-aqueous solution to the water at high enough temperatures to boil off the solvents. The sulfonated block copolymer could also be in solution by use of another organic solvent and thereafter added to water to form an emulsion.

2. Substrate

The moisture permeable polymer disclosed herein is coated on a substrate in an interrupted pattern. Substrates include fabrics, cellulosic material such as paper, as well as synthetic and natural rubbers and foams, as well as natural and synthetic leathers.

The fabrics which can be employed include woven and non-woven materials. Any fibrous material can be suitably employed, including textiles, yarns, and blends, whether knitted, and whether natural, synthetic, or regenerated. Examples of suitable textiles include cellulose acetate, acrylics, wool, cotton, jute, linen, polyesters, polyamides, regenerated cellulose (Rayon), and the like. The fabric can be one layer or multiple layers.

The fabrics can be air permeable or air impermeable. Air impermeable fabrics are generally related to garments for first responders, military, police or garments for dangerous activities or areas. In some cases the garments may be air impermeable to prevent harmful gases or chemicals from reaching a body. The coating is preferably applied to the inside of the garment where such surface will contact the skin.

In some embodiments, the fabrics are air permeable, thus allowing the free flow of air to aid evaporative cooling. Preferably the fabrics are moisture permeable as well.

In some embodiments, the fabrics are preferably air permeable, moisture permeable and have wicking properties. Wicking refers to drawing moisture away from the surface of a substrate, and in preferred embodiments, such substrate is the surface of the skin. Wicking by fibers and yarns can occur by several processes. Wicking is discussed for example in U.S. Pat. No. 7,682,994 along with various wicking fibers treatments.

Wicking may occur for example due to inherent capillary action or by absorbency. Generally hydrophilic fibers tend to wick moisture by absorbency. On the other hand hydrophobic fibers tend to wick moisture by capillary action. Hydrophobic or hydrophilic coatings can also be applied on fibers to give them such properties. While hydrophilic fibers can wick moisture away via absorbency, they can tend to retain moisture, whereas hydrophobic fibers allow for the spreading and more efficient evaporation of moisture.

The wicking fabric disclosed herein can be made up of hydrophilic or hydrophobic fibers or a combination thereof. Naturally hydrophilic fibers include for example cotton, wool and linen. Hydrophobic fibers include for example polyesters and acrylics. Preferably, the fabrics of the present disclosure contain hydrophobic fibers, and in particular contain polyester. Preferably, the garment is from 10-100% hydrophobic fibers, 40-100% hydrophobic fibers, 60-100% hydrophobic fibers, 80-100% hydrophobic fibers, wherein the preferred hydrophobic fiber is a polyester.

The fabric can be simply a sheet or can be formed into an article, such articles including an article of clothing such as garments. The garment can be any wearable fabric, and can be selected for example from shirts, t-shirts, pants, shorts, arm bands, socks, underwear, sweat band, handkerchiefs, towels, skirts, blouses, shoes, gloves, hats and uniforms. The coated surface is preferably on the undersurface of the garment facing the skin of the wearer, and preferably is in contact with the skin. In other embodiments, the substrate can be in form of a throw, i.e., a blanket, sheet or wrap, which can be draped, e.g., over at least a part of a human being or an animal in need of cooling. Substrates can also include fabrics other than that which would be worn, which include for example tents, wrappings, and packaging.

In addition to fabrics, the substrate can be comprised of cellulosic materials such as paper. In particular, beverage bottles and cans are often sold with labeling or attachments with labels which are made up of paper or cellulosic material. A coating of the moisture permeable polymer can be applied to the paper surface which will be directly pressed and attached to the beverage bottles.

In addition to fabrics and cellulosic materials, the substrate may be made up of rubber or plastic. The rubber can be natural or synthetic rubber. Additionally, the rubber or plastic can be fully or partially of a foam material. The rubber or plastic substrate can be shaped into the form of a sleeve in order to be placed around a container, bottle or can and cooling any liquid contained therein.

3. Coating Pattern

The moisture permeable polymer disclosed herein is applied to a substrate in an interrupted pattern. The interrupted pattern means at least a portion of the surface which been coated with the polymer is in fact uncoated, or free from the polymer coating. Thus any interrupted pattern will have a portion of a designated surface area covered with a moisture permeable polymer, but also a portion free and uncovered from the polymer.

With respect to the substrate, and in particular wicking fabric, the interrupted pattern has the synergistic effect of taking advantage of the beneficial properties of the wicking fabric as well as moisture permeable polymer. As discussed herein, the wicking fabric itself promotes enhanced cooling by natural wicking action as well as spreading the moisture for evaporative cooling. The moisture permeable polymer, and in particular the sulfonated block copolymer disclosed herein has enhanced cooling effects by natural wicking action and by absorbing and binding the moisture. Moreover, as the polymer can have greater cooling effects than the wicking fabric itself, the coating of the polymer onto the fabric provides the natural benefit of improving the overall cooling of the fabric or the article comprised of the fabric. Moreover, there is the added synergistic effect in that the wicking fabric can draw moisture from the moisture permeable polymer thus aiding wicking and evaporative cooling. The interrupted pattern takes advantage of the beneficial aspects of the fabric by allowing ease of movement, folding, bending and use of the fabric.

While particular benefits are achieved for fabrics, in particular wicking fabrics, the enhanced cooling effects are also beneficially provided for other substrates disclosed herein, including cellulosic materials, paper, rubbers, plastics, and foam materials. The interrupted pattern permits swelling of the polymer, as well as wicking and binding of moisture to provide enhanced cooling.

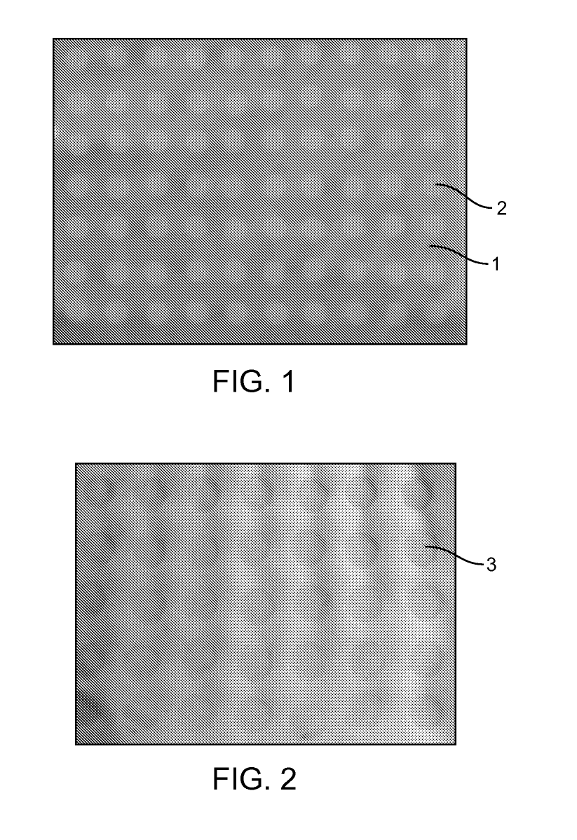

Accordingly, the interrupted pattern can have many forms. One form is shown in FIG. 1, wherein a polymer film 1 has had a plurality of holes 2. The pattern is continuous in the sense that the film 1 is not completely broken within the pattern, where the holes 2 are distributed and separated from one another by the film 1. The holes 2 are provided in this instance in an ordered pattern of linear columns and rows. Another embodiment is shown in FIG. 2, where the interrupted pattern is made up of a plurality of discrete dots 3 of the film. This can be referred to as a discontinuous pattern as the discrete dots of membrane are not connected with one another. Although FIGS. 1 and 2 demonstrate a repeating ordered pattern, in other embodiments, the patterns can be random, or be made up of multiple different shapes or dots. Other patterns can include irregular or regular geometric shapes, outlines of irregular or regular geometric shapes, polygonal shapes, broken or unbroken lines, or combinations of all the above. A plurality of dots of membrane or holes in the membrane can make up such shapes, and furthermore, the dots or holes themselves can have shapes to them as well. Such dots can be wholly or partially filled in.

In any of such shapes a portion of the surface area has a portion coated with the moisture permeable polymer, and a portion remaining uncoated. In some embodiments, from 5% to 95% of the fabric surface remains uncoated, alternatively from 10% to 90% remains uncoated, alternatively from 10 to 80% remains uncoated, alternatively from 15% to 75% remains uncoated, alternatively from 20 to 70% remains uncoated, alternatively from 30 to 60% remains uncoated, alternatively from 35 to 55% remains uncoated, alternatively from 40% to 55% remains uncoated, alternatively from 45% to 55% remains uncoated. Suitable ranges include any combination of the mentioned upper and lower limits even if the particular combination is not specifically listed.

4. Coating Process

There are multiple methods by which the moisture permeable polymer herein can be applied to the substrate. Such methods include presses, thermal lamination, sprays, adhesives, knife-coaters, printing, calendaring or rollers known in the art by which the moisture permeable polymer is applied to the substrate.

With respect to fabrics, papers or more flexible items a preferred method includes gravure coating. Gravure coating is known in the art, and is discussed for example in U.S. Pat. No. 5,597,618. Generally gravure coating involves a gravure roller having a pattern etched on its surface. Such pattern can include those discussed hereinabove. The gravure roller can be placed in contact with a container having the solution containing the moisture permeable polymer or applied its surface. A separate backing roller is provided with the substrate such as fabric. As the substrate is passed between the rollers, the solution is deposited onto the substrate surface. The gravure coating method allows many patterns to be easily implemented and furthermore allows ease in production of the coated fabric.

Blending with Styrenic Block Copolymers

In some embodiments the moisture permeable polymer, and in particular, the sulfonated block copolymer disclosed herein can be blended with at least one hydrogenated styrenic block copolymer. Suitable hydrogenated styrenic block copolymers include, for example, the hydrogenated block copolymers described in U.S. Pat. No. 3,595,942, U.S. Pat. No. Re. 27,145, U.S. Pat. No. 3,700,633, U.S. Pat. No. 4,089,913, U.S. Pat. No. 4,122,134, U.S. Pat. No. 4,267,284, U.S. Pat. No. 4,603,155, U.S. Pat. No. 5,191,024, U.S. Pat. No. 5,306,779, U.S. Pat. No. 5,346,964, U.S. Pat. No. 6,197,889, and U.S. Pat. No. 7,169,848, all of which are herein incorporated by reference.

In some embodiments, the hydrogenated block copolymers have a general configuration A-B, A-B-A, (A-B)ₙ, (A-B-A)ₙ, (A-B-A)ₙX, (A-B)ₙX or a mixture thereof, wherein n is an integer from about 2 to about 30, X is the residue of a coupling agent, each A block independently is a polymer block of one or more alkenyl arenes having a number average molecular weight of from 3,000 to 60,000; and each B block independently is a polymer block of one or more conjugated dienes and from 0 to about 75%-wt. of one or more alkenyl arenes, which block contains no significant levels of olefinic unsaturation and has a number average molecular weight of from 30,000 to 300,000;

wherein the total amount of alkenyl arenes in the hydrogenated block copolymer is from about 2 to about 75%-wt, or from about 5 to about 65%-wt.

In some embodiments, the block copolymers are linear or radial and may include polymers of the following types: polystyrene-polybutadiene (SB), polystyrene-polyisoprene (SI), polystyrene-polybutadiene-polystyrene (SBS), polystyrene-polyisoprene-polybutadiene (SIS), poly(alpha-methylstyrene-polybutadiene-poly(alpha-methylstyrene), poly(alpha-methylstyrene)-polyisoprene-poly(alpha-methylstyrene). Such block copolymers include, e.g., KRATON® D, G and RP Thermoplastic Rubbers. In further particular embodiments, the block copolymers are of S-E/B-S or S-E/P-S block copolymers. Such block copolymers include, e.g., KRATON® A and G Thermoplastic Rubbers.

In accordance with some embodiments, suitable hydrogenated block copolymers generally have an average molecular weight of from about 25,000 to about 350,000, or from about 35,000 to about 300,000. These average molecular weights are determined by conventional techniques such as tritium counting methods or osmotic pressure measurements.

In accordance with some embodiments of suitable hydrogenated block copolymers, the A blocks contribute a total of from about 2%-wt. to about 65%-wt., or from about 5%-wt. to about 55%-wt., or from about 7%-wt. to about 50%-wt., based on the total block copolymer.

In some particular embodiments, the hydrogenated block copolymers comprise one or more B blocks wherein from about 25% to about 60 mole-%, or from about 35 to 55 mole-%, or from about 40 to about 50 mole-%, of the units are the result of 1,2-polymerization. The average molecular weight of a B block is suitably from about 30,000 to about 300,000, or from about 30,000 to about 150,000, or from about 40,000 to about 130,000.

The styrenic block copolymers disclosed herein can comprise from 10 to 90 wt %, 20 to 80 wt %, from 30 to 70 wt %, from 40 to 60 wt %, and combinations of the aforementioned ranges. Blending tends to provide elasticity without significant reduction in cooling properties of the sulfonated block copolymer. Accordingly, such blends are particularly suitable for use for coatings on fabrics and garments.

### Methods for Cooling Articles

In further embodiments, the present disclosure provides for a method of cooling a container or subject which comprises

covering at least a portion of the surface of the container or of the skin of the subject with an article comprising a substrate which has a polymer coating applied to at least one of its surfaces, wherein the polymer coating forms an interrupted pattern such that at least 10% to 80% of the substrate surface remains uncoated, and wherein the polymer coating comprises a moisture permeable polymer,

and wherein the substrate is oriented such that the coated surface faces the surface of the container or the skin of the subject.

As hereinbefore mentioned, it is currently believed that the cooling effect which is provided by the polymer coating involves energy consumption due to swelling of the polymer coating under the influence of moisture or humidity as well as energy consumption due to evaporation of the moisture from the coating. Accordingly, the cooling effect is observed whenever the coating is brought into contact with a surface so long as the cycle of swelling and evaporation of moisture is ensured.

The cooling effect advantageously can be employed to cool subjects such as animals and human beings, in which case the moisture may be provided by perspiration, or by pre-moistening the article, and bringing the coated surface of the optionally pre-moistened article into contact with at least a portion of the skin.

In certain embodiments, the article therefore is in form of a garment and the coating is on a surface of the garment facing the skin. Suitable garments include, in particular, shirts, t-shirts, pants, shorts, arm bands, socks, underwear, sweat bands, handkerchiefs, shoes, gloves, hats and uniforms, and the like. In other embodiments, the article may be in form of a throw, i.e., a blanket, sheet or wrap, which can be draped, e.g., over at least a part of a human being or an animal in need of cooling. Alternatively, a throw may be used to cover surfaces of equipment having elevated temperature prior to handling or use. For example, a throw may be used as a cushioning and cooling layer on seats to be contacted by bare skin such as seats of outdoor furniture, and boat or car seats, or a throw may be used to provide a cooling layer, e.g., around the steering wheel of a boat or car and the like. Similarly, the article may be in form of a handle or grip of sports equipment such as rackets, or a covering therefore. It will be understood by those having ordinary skill that the orientation in each case should be such that the coated surface comes into contact with the skin, and that the throw or handle should be pre-moistened unless perspiration and/or humidity allow for sufficient and continuous swelling and evaporation.

In a corresponding manner, the cooling method may be employed to reduce the temperature of a container, or to prolong the warm-up time of a cooled container after having been exposed to ambient temperature. To this end, the article is advantageously shaped in form of a sleeve adapted to fit around the body of the container in a manner which ensures contact between the coated surface of the article and the outer surface of the container, sufficient moisture to allow swelling of the coating, and sufficient ventilation to ensure evaporation of the moisture.

The method is essentially suited for any type of container, that is, the container may be made from any material which is sufficiently resistant to the humidity necessary to achieve the cooling effect. In certain embodiments, the container may be made from metal, plastic, or glass. In some particular embodiments the method is suited to cool containers for beverages such as bottles and cans. In other particular embodiments, the method is suited to reduce the warming up of cooled containers that are exposed to ambient temperatures thus prolonging the time necessary for the container to reach ambient temperature after exposure. In the event that the method is used to reduce the warming up of cooled containers it is normally not required to provide moisture beyond the humidity of the ambient air which will condense on the cooled container thus initiating the swelling of the coating.

Similarly, the substrate of the sleeve is not narrowly critical so long as it provides sufficient mechanical stability as well as flexibility under the conditions of use, and allows for sufficient ventilation to ensure evaporation of the moisture required to swell the coating. Accordingly, in some embodiments, the substrate may be made from rubber, fabric, or plastic, with the coating being located at least on the surface of the sleeve which is adapted to contact the container. In particular embodiments, the rubber or plastic may be partially or completely foamed.

In further embodiments, the article may be made in the form of a label which is permanently attached to the body of the container. Such labels may be in form of patches or sleeves, and may comprise, as a substrate, a cellulosic material or paper such as, e.g., conventionally employed for labeling the container. Normally, the label should be partially attached to the container with an adhesive, and the remaining surface of the label which is in contact with the container should be provided with the polymer coating.

Those having ordinary skill in the art will appreciate that the cooling effect of the method disclosed herein to a certain extent will depend on the percentage of the container surface which is in contact with the coated surface of article, the amount of moisture, and the efficiency of ventilation. Accordingly, where the cooling of containers is concerned, it is generally preferable that the sleeve or label cover at least 50% of the container surface. In some embodiments, the sleeve or label is adapted to cover at least 70%, or at least 80%, of the container surface.

In some embodiments, when saturated or partially saturated, the polymer coating is cooler than ambient temperature and the immediate uncoated substrate surface in the pattern. In particular, the temperature of the polymer coating is at least 1-12° F. cooler than ambient temperature. In some embodiments the temperature is preferably 2-8° F. cooler, preferably 4-10° F. cooler, more preferably 5-12° F. cooler than ambient, and is preferably at least 5° F. cooler, preferably at least 6° F. cooler, preferably at least 7° F. cooler, more preferably at least 8° F. cooler, more preferably 10° F. cooler, and still more preferably 12° F. cooler than ambient.

In particular, the temperature of the polymer when saturated or partially saturated can be anywhere from 1-4° F. cooler than the temperature of the immediate surrounding substrate surface. In some embodiments the temperature is at least 1-1.5° F. cooler, preferably 2-3° F. cooler, more preferably 2.5-3° F. cooler, more preferably 2.5-4° F. cooler, still more preferably 4-8° F. cooler than the surrounding substrate surface area. In some embodiments, the temperature of the polymer coating more preferably at least 1° F. cooler, preferably 1.5° F. cooler, more preferably 2° F. cooler, more preferably 2.5° F. cooler, at least 3° F. cooler, preferably 3.5° F. cooler, more preferably 4° F. cooler than the immediate surrounding substrate surface.

With respect to cooling containers, such as cans or bottles containing a liquid, the articles disclosed herein applied to such containers are capable of cooling the container by at least 0.5 to 4.5° F. relative to a can without such article applied. In some embodiments, the temperature is decreased by at least 0.5° F., preferably at least 1° F., preferably at least 1.5° F., preferably at least 2° F., preferably at least 2.5° F., preferably at least 3° F., preferably at least 3.5° F., preferably at least 4° F., preferably at least 4.5° F.

Additionally, with respect to inhibiting the rate at which a container warms, a container having a liquid at a temperature of from 30-70° F., the article disclosed decreases the temperature of the liquid relative to a container without the article for at least 0.5-4 hours. In some embodiments, the liquid is cooled relative to a container without the article for at least 0.5 hours, preferably at least 1 hour, preferably at least 1.5 hours, preferably at least 2 hours, preferably at least 2.5 hours, preferably at least 3 hours, preferably at least 3.5 hours, preferably at least 4 hours.

With respect to containers that “sweat”—that is when a container such as a can is placed in a humid environment with a cold liquid, the condensation that appears on the containers surface can saturate the article and provide cooling of at least 2° F., preferably at least 2.5° F., preferably at least 3° F., preferably at least 3.5° F., preferably at least 4° F., preferably at least 4.5° F., preferably at least 5° F., preferably at least 5.5° F., preferably at least 6° F., preferably at least 6.5° F., preferably at least 7° F., or more relative a container without such article.

These temperature differences can also be referred to as ΔT, meaning the difference in temperature between the saturated or partially saturated polymer coating and ambient temperature or the immediate uncoated substrate surface in the pattern.

Temperatures can be determined by conventional methods including thermometers and thermal imaging.

In addition, the coating applied to the substrates can vary in thickness from 1-100 mil, alternatively from 10-80 mil, alternatively from 20-70 mil, alternatively from 30-60 mil.

### ILLUSTRATIVE EMBODIMENTS

The following examples are intended to be illustrative only, and are not intended to be, nor should they be construed as, limiting the scope of the present invention in any way.

a. Materials and Methods

Degree of Sulfonation:

The degree of sulfonation as described herein and as determined by titration was measured by the following potentiometric titration procedure. The sulfonation reaction product solution was analyzed by two separate titrations (the “two-titration method”) to determine the levels of styrenic polymer sulfonic acid, sulfuric acid, and non-polymeric by-product sulfonic acid (2-sulfoisobutyric acid). For each titration, an aliquot of about five (5) grams of the reaction product solution was dissolved in about 100 mL of tetrahydrofuran and about 2 mL of water and about 2 mL of methanol were added. In the first titration, the solution was titrated potentiometrically with 0.1 N cyclohexylamine in methanol to afford two endpoints; the first endpoint corresponded to all sulfonic acid groups in the sample plus the first acidic proton of sulfuric acid, and the second endpoint corresponded to the second acidic proton of sulfuric acid. In the second titration, the solution was titrated potentiometrically with 0.14 N sodium hydroxide in about 3.5:1 methanol:water to afford three endpoints: The first endpoint corresponded to all sulfonic acid groups in the sample plus the first and second acidic proton of sulfuric acid; the second endpoint corresponded to the carboxylic acid of 2-sulfoisobutyric acid; and the third endpoint corresponded to isobutyric acid.

The selective detection of the second acidic proton of sulfuric acid in the first titration, together with the selective detection of the carboxylic acid of 2-sulfoisobutyric acid in the second titration, allowed for the calculation of acid component concentrations.

The degree of sulfonation as described herein and as determined by ¹H-NMR was measured using the following procedure. About two (2) grams of non-neutralized sulfonated polymer product solution was treated with several drops of methanol and the solvent was stripped off by drying in a 50° C. vacuum oven for approximately 0.5 hours. A 30 mg sample of the dried polymer was dissolved in about 0.75 mL of tetrahydrofuran-d₈ (THF-d₈), to which was then added with a partial drop of concentrated H₂SO₄ to shift interfering labile proton signals downfield away from aromatic proton signals in subsequent NMR analysis. The resulting solution was analyzed by ¹H-NMR at about 60° C. The percentage styrene sulfonation was calculated from the integration of ¹H-NMR signal at about 7.6 part per million (ppm), which corresponded to one-half of the aromatic protons on sulfonated styrene units; the signals corresponding to the other half of such aromatic protons were overlapped with the signals corresponding to non-sulfonated styrene aromatic protons and tert-butyl styrene aromatic protons.

The ion exchange capacity as described herein was determined by the potentiometric titration method described above and was reported as milliequivalents of sulfonic acid functionality per gram of sulfonated block copolymer.

b. Experiments

### Preparation of Sulfonated Block Copolymer SBC-1

A pentablock copolymer having the configuration A-D-B-D-A was prepared by sequential anionic polymerization where the A blocks are polymer blocks of para-tert-butylstyrene (ptBS), the D blocks were comprised of polymer blocks of hydrogenated isoprene (Ip), and the B blocks were comprised of polymer blocks of unsubstituted styrene (S). Anionic polymerization of the t-butylstyrene in cyclohexane was initiated using sec-butyllithium affording an A block having a molecular weight of 15,000 g/mol. Isoprene monomers were then added to afford a second block with a molecular weight of 9,000 g/mol (ptBS-Ip-Li). Subsequently, styrene monomer was added to the living (ptBS-Ip-Li) diblock copolymer solution and was polymerized to obtain a living triblock copolymer (ptBS-Ip-S-Li). The polymer styrene block was comprised only of polystyrene having a molecular weight of 28,000 g/mol. To this solution was added another aliquot of isoprene monomer resulting in an isoprene block having a molecular weight of 11,000 g/mol. Accordingly, this afforded a living tetrablock copolymer structure (ptBS-Ip-S-Ip-Li). A second aliquot of para-tert butyl styrene monomer was added, and polymerization thereof was terminated by adding methanol to obtain a ptBS block having a molecular weight of about 14,000 g/mol. The ptBS-Ip-S-Ip-ptBS was then hydrogenated using a standard Co²⁺/triethylaluminum method to remove the C═C unsaturation in the isoprene portion of the pentablock. The block polymer was then sulfonated directly (without further treatment, not oxidizing, washing, nor “finishing”) using an i-butyric anhydride/sulfuric acid reagent. The hydrogenated block copolymer solution was diluted to about 10% solids by the addition of heptane (roughly an equal volume of heptane per volume of block copolymer solution). Sufficient i-butyric anhydride and sulfuric acid (1/1 (mol/mol)) were added to afford 2.0 meq of sulfonated polystyrene functionality per g of block copolymer. The sulfonation reaction was terminated by the addition of ethanol (2 mol ethanol/mol of i-butyric anhydride) The resulting polymer was found, by potentiometric titration, to have an “Ion Exchange Capacity (IEC)” of 2.0 meq of —SO₃H/g of polymer. The solution of sulfonated polymer had a solids level of about 10% wt/wt in a mixture of cyclohexane and heptane (˜2:1), and a small amount of ethyl i-butyrate (the ethyle i-butyrate is a by-product of the sulfonation reaction).

For use of cast films, the compositions as described above were cast against release liner such as siliconized PET film. Films were allowed to gradually dry in the oven controlled by zoned temperatures and air or nitrogen purge for a period of at least 2 minutes until reaching the desired residual solvent level. No further post-treatments of the film were performed except those specifically required by particular testing procedures. Typical film thicknesses obtained by this procedure range from 5 microns to 50 microns. SBC-1 was cast and formed into films according to this method.

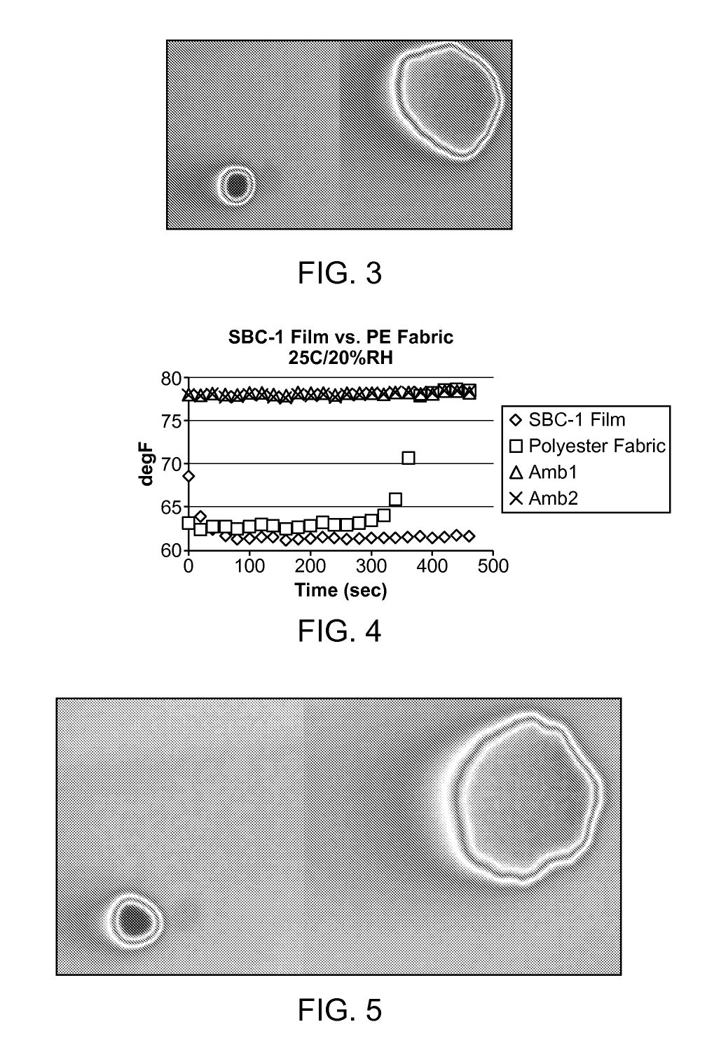

In one test shown in FIG. 3, the cooling effect of SBC-1 was compared to a wicking polyester fabric as measured using an IR camera. In this test, a droplet of water at ambient temperature is applied to the membrane (left) and the wicking fabric (right). Notably, the wicking fabric performs its function well, spreading the droplet of water out over a significantly larger surface area than the droplet (of equivalent volume) on the SBC-1 membrane. Additionally, the water droplet is cooled by >10° F. relative to ambient on both the membrane and fabric. Significantly, the water droplet on the SBC-1 membrane is cooler than the droplet on the fabric as indicated by the darker blue color. This difference in temperature between the membrane and the fabric, ΔT, is about 1.5 to 2° F.

FIG. 4 is an example of what the temperature vs. time for SBC-1 as compared to a wicking fabric. The fabric reaches a plateau temperature from 30 sec to 1 minute faster than the SBC-1 membrane, but the membrane ultimately reaches a lower temperature and maintains that ΔT through the remainder of the experiment. The fabric begins to dry typically in about 5 minutes and demonstrates a corresponding increase in temperature until the fabric recovers back to ambient. The SBC-1 membrane does not show indications of drying even at times exceeding 15 minutes and maintains a constant temperature throughout. This is an indication of the ability of the SBC-1 to absorb and bind moisture.

As shown in FIG. 5, a similar result (ΔT of about 1.5 to 2° F.) is obtained for a composition a membrane made from a blend of SBC-1 (85 wt %) and an SEBS copolymer (15 wt %). With the addition of an SEBS, there is a lower dry modulus and thus may be more suitable for fabric applications.

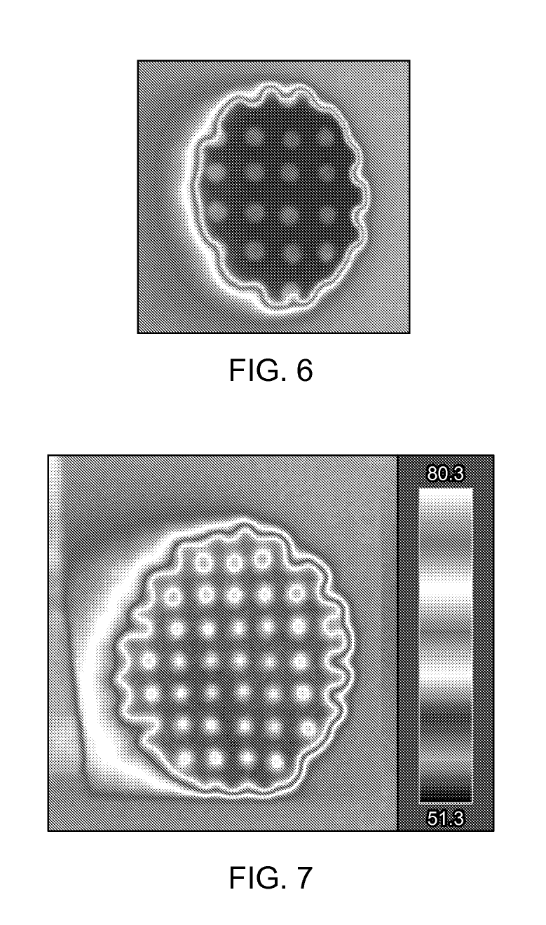

FIG. 1 shows a laminate (thermally laminated) of an SBC-1 membrane on a polyester fabric with a plurality of holes placed in the membrane. FIG. 6 shows the corresponding thermal image when a droplet of water is applied. Similar to an unblended SBC-1 membrane in FIG. 3, there is shown here a 1.5 to 2° F. ΔT between the membrane and the fabric along with the fabric's ability to effectively wick the water droplet over a larger surface area.

With respect to solution coating, a cyclohexane based solution of SBC-1 (11% solids content) was coated on a polyester fabric in a dot pattern as shown in FIG. 2. FIG. 7 shows the corresponding thermal image. As shown, both the fabric and SBC-1 portions are cooled, however, the SBC-1 is not cooled to the same extent as seen with the aforementioned laminates of the cast film. In fact, in all of the dots (SBC-1 coating) were actually warmer than the surrounding fabric when a drop of water was applied. It is believed that the viscosity of the cyclohexane solution was too low making it difficult to maintain the individual integrity in the dot pattern. There was also significant bleed through to the back side of the fabric.

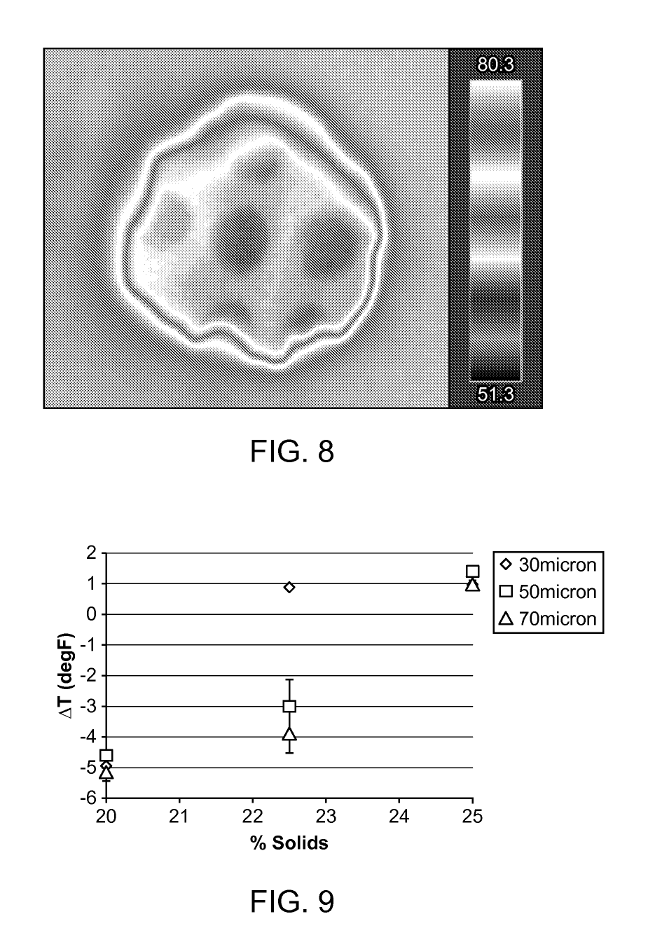

In order to obtain higher viscosities, a THF/ethanol (2:1) solution with a solids content of 25% was tested. With this solution, a successful coating of the polyester fabric in a dot pattern was obtained which displayed similar cooling performance to the aforementioned membranes and laminates. FIG. 8 shows a thermal image where the temperature of the SBC-1 dots were typically ˜1.5° F. lower than the surrounding fabric.

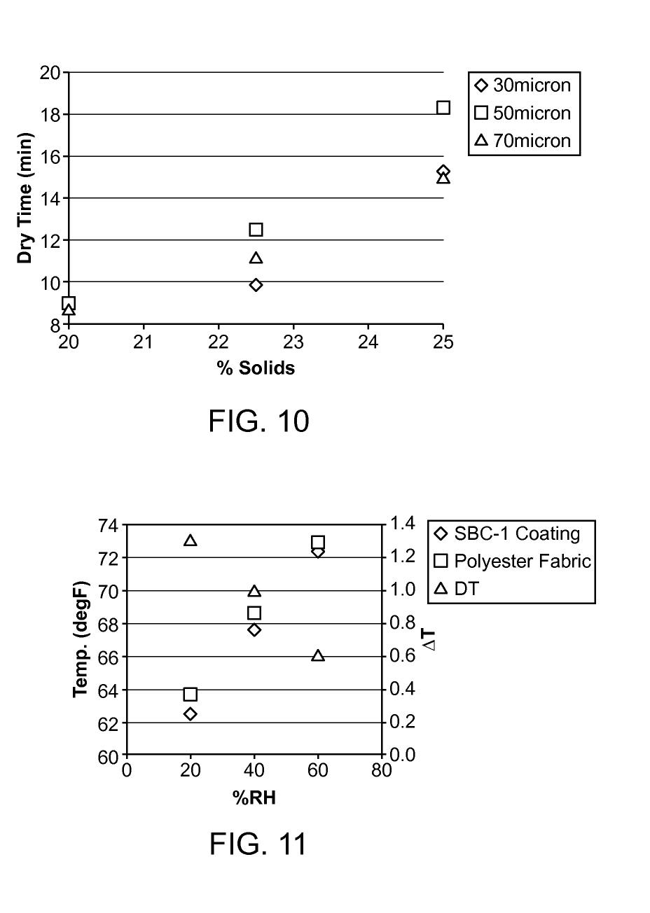

In the table 1, there is tested SBC-1 in a THF/ethanol solution at various solids content and wet thickness (gauge). The data is plotted with the influence of solids content and gauge thickness on ΔT shown in FIG. 9 and the influence of solids content and gauge thickness on dry time shown in FIG. 10.

TABLE 1

| | | | | Gauge | Avg. ΔT | Avg. Dry |
|---|---|---|---|---|---|---|
| Ex. | Sample | solvent | % solids | (μm) | (° F.) | Time |
| 1 | SBC-1 | THF/ethanol | 20 | 30 | −4.9 | 8.9 |
| 2 | SBC-1 | THF/ethanol | 20 | 50 | −4.6 | 9 |
| 3 | SBC-1 | THF/ethanol | 20 | 70 | −5.1 | 8.7 |
| 4 | SBC-1 | THF/ethanol | 22.5 | 30 | 0.9 | 9.9 |
| 5 | SBC-1 | THF/ethanol | 22.5 | 50 | −3 | 12.5 |
| 6 | SBC-1 | THF/ethanol | 22.5 | 70 | −3.8 | 11.2 |
| 7 | SBC-1 | THF/ethanol | 25 | 30 | 1 | 15.3 |
| 8 | SBC-1 | THF/ethanol | 25 | 50 | 1.4 | 18.3 |
| 9 | SBC-1 | THF/ethanol | 25 | 70 | 1 | 15 |

In table 1, ΔT was driven predominantly by the solids content of the solution, which affects the viscosity of the solution. The 25% solids solution was the only one that resulted in positive ΔT values for all three thicknesses evaluated. At 20% solids, the ΔT values were all negative, indicating a warmer dot similar to what was observed with the cyclohexane solutions. This result indicates a narrow solids (or viscosity) range over which a coated sample will demonstrate the desired result. With this technique, the optimal viscosity range will depend on the application method. Gauge thickness had a minor, although consistent, effect on ΔT that was non-linear. With the exception of the 22.5% solids sample at 30 microns gauge thickness, the 50 micron gauge thickness demonstrated higher ΔT values than either the 30 or 70 micron samples. The drying time response demonstrated similar trends to the ΔT response. Drying time increased roughly two times when the solids content was increased from 20 to 25%. As with ΔT, the response to gauge thickness was non-linear, with the 50 micron thickness resulting in the longest drying time at each solids concentration. The 30 μm, 22.5% solids sample performed consistent with the other samples with respect to this response.

The relationship between temperature and ΔT and humidity is demonstrated in FIG. 11 for a sample coated from a 25% solids solution with a 50 μm gauge thickness. The results show that both the fabric and SBC-1 polymer dot are inhibited in their ability to cool at higher % relative humidity (% RH). This is consistent with the idea of evaporative cooling, because evaporation from both the fabric and SBC-1 polymer will be impeded as % RH increases.

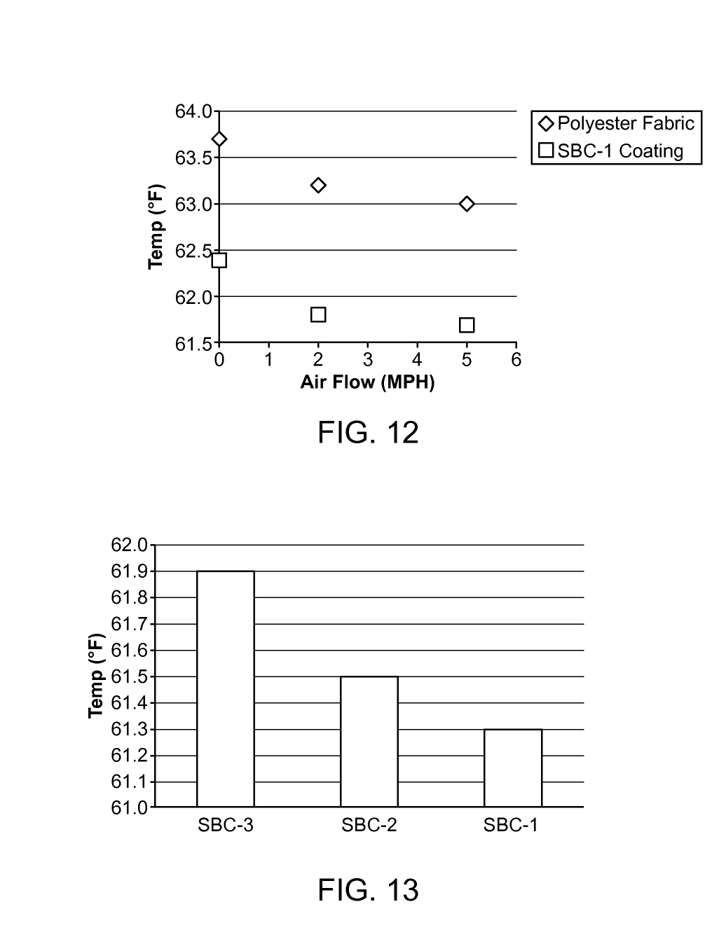

Testing was conducted in response to added air flow over the coated fabric, with results shown in FIG. 12. For this test, a fan was placed inside the environmental chamber and was positioned to blow air horizontally across the sample surface. Two different air flow rates, as measured at the sample surface, were achieved. Increasing air flow across the sample did result in a lower temperature for both the fabric and the Nexar polymer dot while the ΔT remained constant. This is again consistent with the concept of evaporative cooling.

An additional test was conducted regarding swelling of SBC-1 as compared to similar sulfonated block copolymer having lower levels of sulfonation. In particular, SBC-2 and SBC-3 were prepared in the same way as SBC-1 but having sulfonation levels of 1.5 meq and 1.0 meq respectively. A droplet of water was placed on membranes prepared from each of these polymers and absolute temperature measured with results shown in FIG. 13. Generally, with greater sulfonation levels, upon absorption of water the amount of swelling increases. In view of this, the results show that as the ability of the membrane to swell increased so did the effectiveness of the evaporative cooling process with SBC-3 resulting in the highest temperature and SBC-1 resulting in the lowest. Again, this supports the hypothesized mechanism that the ability of the sulfonated polymers to swell impacts their cooling behavior and enhances the process of evaporative cooling.

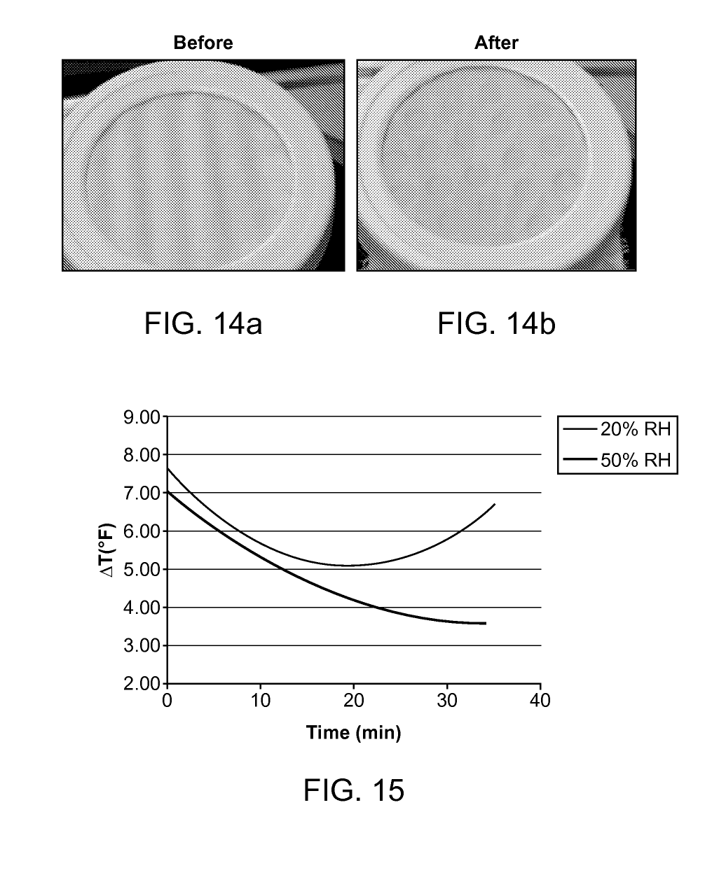

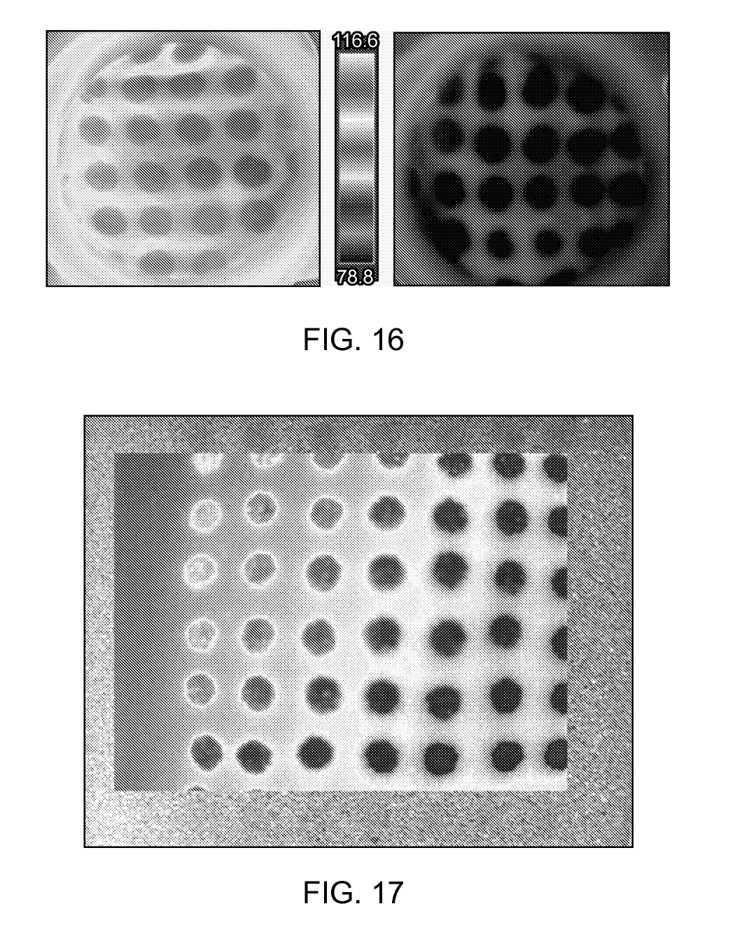

FIG. 14a and FIG. 14b shows an example of the visible response of the SBC-1 dots, induced by swelling, on a polyester fabric when subjected to the moisture vapor, with FIG. 14a showing before and FIG. 14b showing after exposure demonstrating the dots swelling toward the moisture source. As shown in FIG. 15, immediately following saturation with the moisture vapor the ΔT at 20% ambient RH is ˜7.5° F. and the ΔT does not drop below 5° F. as the sample is allowed to cool. The ΔT increase observed at the end of the experiment is the result of the fabric drying and increasing in temperature while the SBC-1 polymer dots remain saturated and cool. FIG. 16 are thermal images taken at different points during the experiment demonstrating the extreme temperature difference between the dots and the fabric. Even at 50% RH, the ΔT remains above 3° F. for the entire test.

FIG. 17 illustrates a SBC-1 coated in a dot pattern on the surface of polyurethane foam after exposure to 80% relative humidity. As shown, cooling occurs even without the addition of a droplet of water.

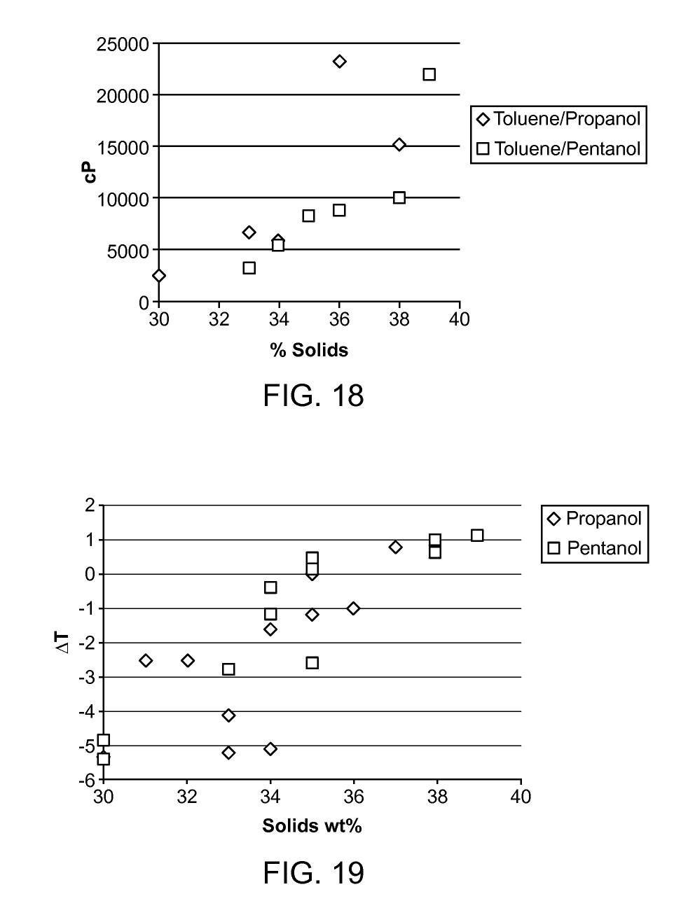

For longer runs on a gravure system, it may be desirable to use a less volatile solvent than a THF based solution to avoid high viscosities related to evaporation. Accordingly, testing was conducted with a solution of toluene/alcohol (2:1), where the alcohol is propanol or pentanol. FIG. 18 shows the relationships between solids content and viscosity and FIG. 19 shows the cooling performance (ΔT), respectively, for both 2:1 toluene/alcohol solvent systems.

Additional testing was conducted with respect to inhibiting the warming of containers containing liquid. Testing was accomplished by filling a beaker with water at the desired temperature and filling aluminum cans labeled herein as container 1 (C-1) and comparative container 2 (CC-2) to ˜¾ full from the beaker (˜200 mL). An Oakton Temp300 digital thermometer with data logging and dual probes was used to monitor temperature in both C-1 and CC-2 simultaneously over time. The test can C-1 was wrapped from top to bottom with a single layer of 0.5 mil thick SBC-1. CC-2 remained unwrapped. Depending on the specific experiment, the SBC-1 was either pre-spritzed with room temperature (˜75° F.) distilled water or was wrapped around can C-1 dry. The thermometer probes were placed directly into the water inside the test and control cans and held in place throughout the experiment. Three different experiments (Ex. 10-13) were performed by this general method. In Ex. 10, room temperature water was added to the cans C-1 and CC-2 and the SBC-1 was pre-spritzed. This was repeated to confirm results in Ex 11. In Ex. 12, cold tap water was added to the cans C-1 and CC-2 and the SBC-1 was pre-spritzed. In Ex. 14, C-1 was filled with ice water wrapped in dry SBC-1 and placed outside where the temperature was ˜85° F.

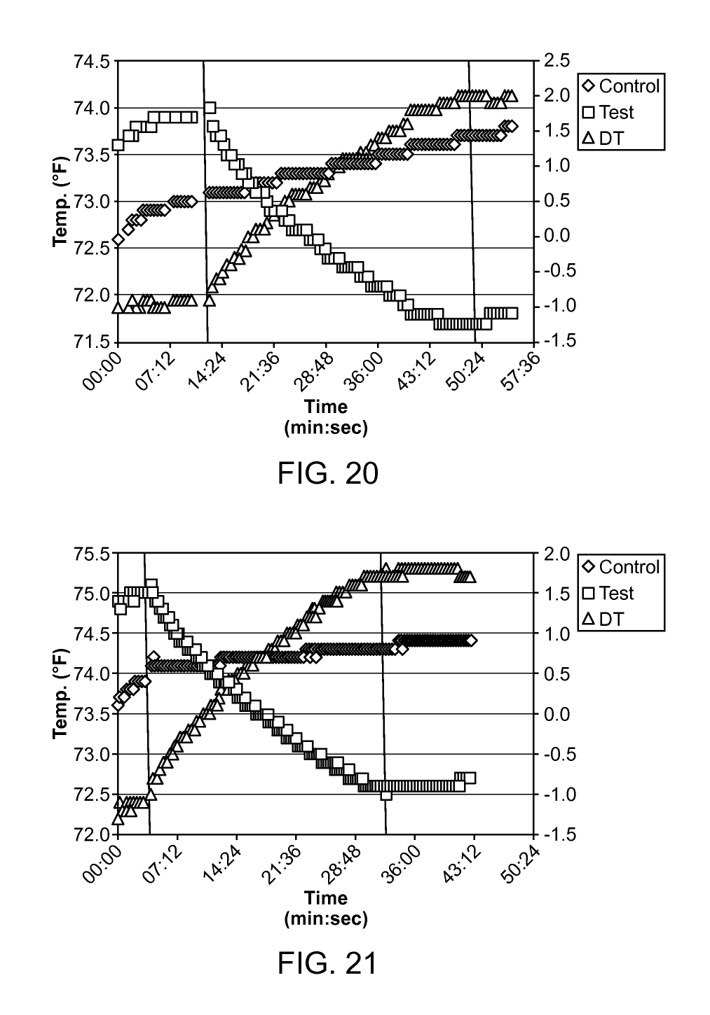

The results for Ex. 10 are shown in FIG. 20. As shown, the temperature of the water in the test can dropped ˜2.5° F. over a span of ˜25 minutes. The temperature of the water in the CC-2 actually increased by 1° F. over the same span. This resulted in a ΔT increase of nearly 3.5° F. between the test and control can throughout the experiment. Once the SBC-1 film was removed, the temperature of the water in C-1 plateaued for a period of time before beginning to increase just as the experiment was terminated.

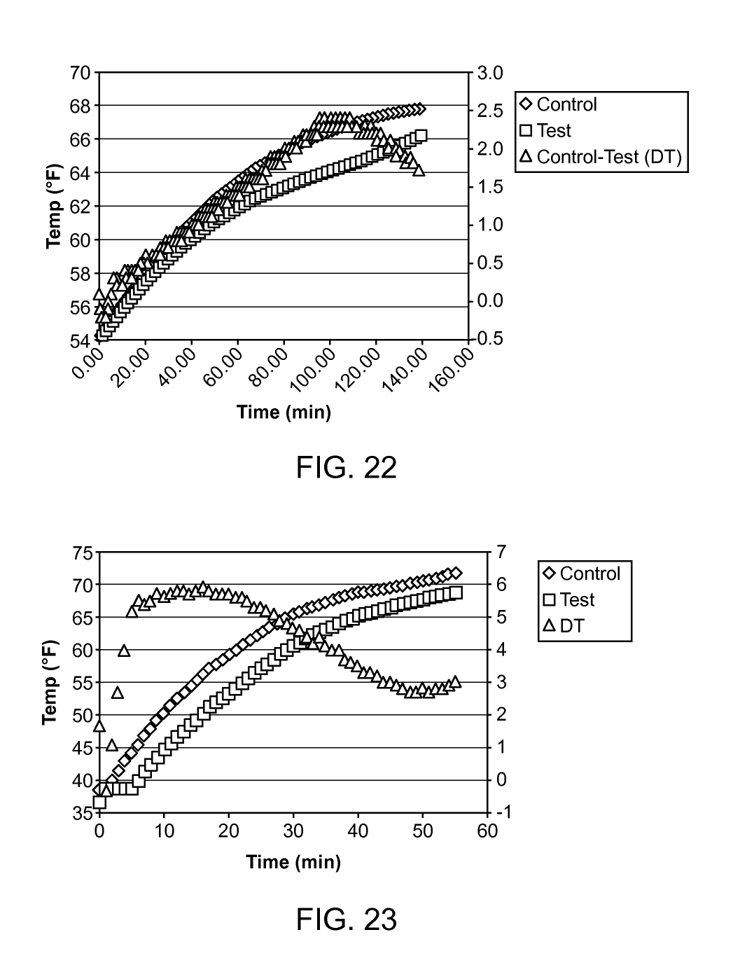

Ex. 11 (a repeat of Ex. 10) is consistent with the results shown in FIG. 21. In particular, as shown in FIG. 22, the temperature of the water in the test can drops almost 2.5° F. again over the course of the measurement. Also similar to the initial experiment, the ΔT between the two cans increased by ˜3° F. Finally, a similar temperature plateau and initial increase was observed once the SBC-1 film was removed from C-1

The repeat of the initial experiment was remarkably consistent. As shown in FIG. 17, the temperature of the water in the test can drops almost 2.5° F. again over the course of the measurement. Also similar to the initial experiment, the ΔT between the two cans increased by ˜3° F. Finally, a similar temperature plateau and initial increase was observed once the SBC-1 film was removed.

The results for Ex. 13 are shown in FIG. 22. These results show that SBC-1 can in fact, be used to inhibit the warming process. ΔT increases up to about 90-95 minutes reaching a maximum value of nearly 2.5° F. ΔT begins to decrease again as the SCB-1 dries out and the can begins warming at an uninhibited rate. A rough approximation calculated from the slope of the decreasing portion of the ΔT curve indicates that it would take ˜210 minutes (3.5 hours) for ΔT to reach zero.

The results for Ex. 15 are shown in FIG. 23. The results show that the natural “sweating” process (or condensation) that occurs when a can with cold water is placed in a hot, humid environment would be sufficient to activate the cooling attribute of SBC-1. The results shown in FIG. 24 demonstrate that the “sweating” process is extremely effective at generating the desired response with ΔT values approaching 6° F. during the experiment. Over the initial 5 minutes of the experiment, the rate of warming of CC-2 is actually 21× faster than C-1 which is wrapped with SBC-1.

Additional examples 15-18 were also conducted regarding containers as shown in Table 2.

TABLE 2

| Experi- | | Ambient | Ambient | Container | SBC-1 | Max |
|---|---|---|---|---|---|---|
| ment | Water | Temp | RH | Substrate | Thickness | ΔT |
| 15 | ICE | 30 | 85 | Aluminum | 1.4 | 4.7 |
| 16 | ICE | 30 | 45 | Glass | 1.4 | 3.4 |
| 17 | ICE | 38 | 85 | Glass | 1.4 | 5 |
| 18 | ICE | 38 | 85 | PETE | 1.4 | 5.5 |

In each example, the test and control containers were filled with ice water and placed in a controlled environment chamber at the specified temperature and humidity. The test container was wrapped as described for experiments 10-13. The “Max DT” corresponds to the maximum temperature difference between the test and control substrates during the experiment where a positive value indicates that the control can was at a higher temperature.

1. An article comprising:
a substrate which has a polymer coating applied to at least one of its surfaces, wherein the polymer coating forms an interrupted pattern such that at least 10% to 80% of the substrate surface remains uncoated, and wherein the polymer coating comprises a moisture permeable polymer.

2. The article of claim 1, wherein the moisture permeable polymer is a sulfonated polymer with a hydrocarbon backbone.

3. The article of claim 2, wherein the sulfonated polymer is a sulfonated block copolymer having at least one end block A and at least one interior block B wherein each A block contains essentially no sulfonic acid or sulfonate ester functional groups and each B block is a polymer block containing from about 10 to about 100 mol % sulfonic acid or sulfonate ester functional groups based on the number of sulfonation susceptible monomer units of the B block.

4. The article of claim 1, wherein the substrate is an air permeable fabric.

5. The article of claim 4, wherein the fabric is moisture wicking and comprises hydrophobic fibers.

6. The article of claim 5, wherein the fabric is moisture wicking due to capillary action.

7. The article of claim 5, wherein at least one surface of the fabric is treated with a hydrophilic finish.

8. The article of claim 5, wherein the hydrophobic fibers comprise a polyester.

9. The article of claim 4, wherein the fabric is moisture wicking and comprises hydrophilic fibers.

10. The article of claim 4, wherein the fabric is a garment selected from the group consisting of a shirt, t-shirt, pants, shorts, arm bands, socks, underwear, sweat band, handkerchief, shoes, gloves, tents and hats and uniforms.

11. The article of claim 1, which is in form of a garment or a part of a garment having the polymer coating on the surface of the garment oriented toward the wearer.

12. The article of claim 1, wherein the substrate comprises foam.

13. The article of claim 1, wherein the article is in the shape of a sleeve and shaped for enclosing a portion of a can or bottle.

14. The article of claim 1, wherein the substrate comprises cellulosic material, paper, rubber or plastic.

15. The article of claim 14, wherein the cellulosic material, paper, or plastic is in the form of a label for beverage bottles or cans.

16. The article of claim 1, wherein at least 20% to 75% of the substrate surface remains uncoated.

17. The article of claim 1, wherein the polymer coating further comprises at least one styrenic block copolymer which is optionally functionalized with functional groups different from sulfonic acid or sulfonate ester functional groups.

18. The article of claim 1, wherein the interrupted pattern comprises irregular or regular geometric shapes, outlines of irregular or regular geometric shapes, broken or unbroken lines, or combinations thereof.

19. The article of claim 18, wherein the interrupted pattern comprises a plurality of discrete dots.

20. A process for making an article comprising a substrate, which process comprises:
preparing a solution or dispersion containing a sulfonated hydrocarbon copolymer and at least one solvent and having a solids content of at least 8 to 35 wt %,
coating said solution or dispersion on at least one surface of a substrate in an interrupted pattern such that at least 10% to 80% of the substrate surface remains uncoated.

21. The process of claim 20 wherein the dispersion is an aqueous dispersion.

22. The process of claim 20, wherein the solution or dispersion comprises an organic solvent.

23. The process of claim 20, wherein the solution or dispersion comprises a cyclic or acyclic aliphatic solvent.

24. The process of claim 22, wherein the organic solvent comprises at least one heterocyclic solvent.

25. The process of claim 22, wherein the organic solvent comprises an aromatic hydrocarbon.

26. The process of claim 20, wherein the solution or dispersion comprises a mixture of a polar and a non-polar solvent.

27. The process of claim 20, wherein the organic solvent has a boiling point of at least 90° C.

28. The process of claim 20, wherein the solution or dispersion comprises an alcohol.

29. The process of claim 20, wherein the solution or dispersion has a viscosity below 12,000 cps.

30. The process of claim 20, wherein the solution or dispersion has a low shear viscosity below 6,000 cps.

31. A method of cooling a container or subject comprising:
covering at least a portion of the surface of the container or of the skin of the subject with an article comprising
a substrate which has a polymer coating applied to at least one of its surfaces, wherein the polymer coating forms an interrupted pattern such that at least 10% to 80% of the fabric surface remains uncoated, and wherein the polymer coating comprises a moisture permeable polymer,
and wherein the substrate is oriented such that the coated surface faces the surface of the container or faces the skin of the subject.

32. The method of claim 31, wherein the moisture permeable polymer is a sulfonated polymer with a hydrocarbon backbone.

33. The method of claim 31, wherein the sulfonated polymer is a sulfonated block copolymer having at least one end block A and at least one interior block B wherein each A block contains essentially no sulfonic acid or sulfonate ester functional groups and each B block is a polymer block containing from about 10 to about 100 mol % sulfonic acid or sulfonate ester functional groups based on the number of sulfonation susceptible monomer units of the B block.

34. The method of claim 31, wherein the coating swells under the influence of humidity or moisture to induce a cooling effect capable of reducing the temperature of the surface of the container or the skin of the subject.

35. The method of claim 31, wherein the subject is a human being and the coating contacts at least a portion of the skin.

36. The method of claim 35, wherein the article is a garment and the coating is on a surface of the garment facing the skin.

37. A method of claim 36, wherein the substrate is a fabric.

38. The method of claim 37, wherein the article is selected from the group consisting of a shirt, t-shirt, pants, shorts, arm bands, socks, underwear, sweat band, handkerchief, shoes, gloves, hats and uniforms.

39. The method of claim 31, wherein the container is in form of a can or bottle, and the coating contacts at least a portion of the surface.

40. The method of claim 39, wherein the article is in form of a sleeve adapted to fit around the body of the container, or in form of a label permanently attached to the body of the container.

41. A method of claim 40, wherein the substrate is a cellulosic material or paper, or plastic.

42. The method of claim 39 wherein the container is made from a material selected from metal, plastic, and glass.

43. The method of claim 39, wherein the article is made from fabric, rubber, or plastic, and the coating is located at least on the surface of the article adapted to contact the container.

44. An article comprising:
a moisture wicking fabric which has a sulfonated block copolymer coating applied to at least one of its surfaces, wherein the polymer coating forms an interrupted pattern such that at least 10% to 80% of the substrate surface remains uncoated, and wherein the polymer coating comprises a moisture permeable polymer,
the sulfonated block copolymer having at least one end block A and at least one interior block B wherein each A block contains essentially no sulfonic acid or sulfonate ester functional groups and each B block is a polymer block containing from about 10 to about 100 mol % sulfonic acid or sulfonate ester functional groups based on the number of sulfonation susceptible monomer units of the B block.

45. The article of claim 44, wherein the interrupted pattern comprises a plurality of discrete dots.

46. The article of claim 44, wherein the moisture wicking fabric comprises polyester.

47. A process for making an article comprising a substrate, which process comprises:
preparing a solution containing a sulfonated block copolymer and at least one organic solvent and having a solids content of at least 8 to 35 wt %,
coating said solution on at least one surface of a substrate in an interrupted pattern such that at least 10% to 80% of the substrate surface remains uncoated,
the sulfonated block copolymer polymer is a sulfonated block copolymer having at least one end block A and at least one interior block B wherein each A block contains essentially no sulfonic acid or sulfonate ester functional groups and each B block is a polymer block containing from about 10 to about 100 mol % sulfonic acid or sulfonate ester functional groups based on the number of sulfonation susceptible monomer units of the B block.

48. The process of claim 47, wherein the organic solvent comprises toluene and at least one alcohol.
